(19) United States
(12) Patent Application Publication
(10) Pub. No.: US 2018/0322396 A1
(43) Pub. Date: Nov. 8, 2018

(54) Knowledge Process Modeling and Automation

(71) Applicants: Shruti Ahuja-Cogny, Brooklyn, NY (US); Adrien Cogny, Brooklyn, NY (US)

(72) Inventors: Shruti Ahuja-Cogny, Brooklyn, NY (US); Adrien Cogny, Brooklyn, NY (US)

(21) Appl. No.: 15/810,451

(22) Filed: Nov. 13, 2017

Related U.S. Application Data
(63) Continuation-in-part of application No. 15/155,033, filed on May 15, 2016.
(60) Provisional application No. 62/162,370, filed on May 15, 2015.

(51) Int. Cl. G06N 5/02; G06Q 10/06; G10L 15/26

(52) U.S. Cl. CPC G06N 5/02; G10L 15/265; G06Q 10/067

(57) ABSTRACT

A method for automating knowledge-based processes and operations includes a computer receiving an information dataset comprising knowledge and organizing the information dataset into a plurality of information elements. The computer maps the plurality of information elements into knowledge processes expressed in a knowledge process modeling language. Then, the computer converts the knowledge processes into a knowledge process executable language. Alternatively (or additionally), the computer translates the knowledge processes in a business process model language and converts the translated knowledge processes into a business process executable language.

### RELATED APPLICATIONS

This application is a continuation-in-part application of U.S. patent application Ser. No. 15/155,033 filed on May 15, 2016, and claims the benefit of priority to U.S. Provisional Patent Application No. 62/162,370 filed on May 15, 2015, the entire disclosures of which are hereby expressly incorporated by reference.

### BACKGROUND

### Technical Field

The present disclosure relates generally to methods, systems, and apparatuses for modeling and automating knowledge processes using computing systems.

### Background

Business Process Modeling (BPM) refers to the representation of processes of an enterprise, with the goal of improving business operations. One benefit of BPM is that it can lead to automation of the processes (e.g., via executable code), thereby providing the enterprise with more efficient operations. To date, the field of BPM has not been able to cater to knowledge-based professions and processes due to the complexity of automating knowledge and human intelligence.

Artificial Intelligence (AI), which focuses more on the study of human intelligence and computing, is vast and at a nascent stage. It has focused largely on (i) solutions where intelligence is based on large data sets collected to develop a machine intelligence, (ii) on expert systems which focus on automating knowledge-based areas but rely on the manual collection of knowledge, generally introduced into shell systems for automation of specific processes, and (iii) on natural language processing (which also uses big data machine learning and/or semantics and other language based approaches).

None of the above BPM or AI approaches provides a modeling solution for knowledge-based activities and their processes and documents, which are often based on small sets of more custom data, and/or deal with complex and expert knowledge which is specific to each process. Knowledge processes remain therefore difficult to model and fully automate from knowledge collection to its usage (e.g., providing legal advice, medical diagnostics, compliance work, contract generation etc.). Additionally knowledge based processes are built on complex, textual knowledge and cannot be easily automated through drag and drop techniques or workflows which can stay manual and can also cannot handle large quantities of text based information. Moreover, current systems rely on manual identification of information elements in a document, and require significant processing power to convert a document into executable code.

Additionally, for automated document generation, current techniques can create a document where an initial document is generated with variables which are then required to be filled in to generate a case-based document. The problem with this method is that it requires a user to fill on in static variables on a specifically static document and can handle knowledge based integration which can automatically generate and insert information elements for a user for all cases as the document is generated according to choices as well as ensuring sub-level variable utilization within complex document building.

### SUMMARY

Embodiments of the present invention address and overcome one or more of the above shortcomings and drawbacks, by providing methods, systems, and apparatuses related to a knowledge process modeling and automation tool which enables end-to-end and full scope automation of various knowledge-related work and other knowledge-intensive operations. The invention of the present disclosure is broad and can relate to the end-to-end system of the present disclosure as will be explained in greater detail below. In some embodiments, the present disclosure develops a specific knowledge process modeling language and a computer executable knowledge process language for expertise sharing and work performance. Moreover, in some embodiments, the proposed technology also creates the equivalent of a specific sub domain of business process modeling in the domain of knowledge processes here again in order to provide for expertise sharing and work performance in the knowledge-based space. Additionally and/or independently, the invention of the present disclosure can interface with specific sub-groups of business processes for implementation or as well as some other business process executable language. Further, in some embodiments, the technology builds a specific kind of AI especially adapted to the field of knowledge processes and operations, due to the high level of structuring and logic in business related thought processes and the rigorous construction of knowledge processes, which can lead to decision making algorithms. The proposed technology applies to knowledge processes in the business and professional environments and is described within these environments. Additionally, it may also apply to knowledge activities in non-business environments as it caters to all knowledge based operations and their processes.

According to some embodiments, a method for automating knowledge-based processes and operations includes a computer receiving an information dataset comprising knowledge and organizing the information dataset into a plurality of information elements. The computer maps the plurality of information elements into knowledge processes expressed in a knowledge process modeling language. Then, the computer converts the knowledge processes into a knowledge process executable language. Alternatively (or additionally), the computer translates the knowledge processes in a business process model language and converts the translated knowledge processes into a business process executable language. In some embodiments, the computer also uses the business process executable language or the knowledge process executable language to automate one or more knowledge-based processes.

The information dataset used in the aforementioned method may comprise, for example, a document or text and the information elements may comprise document or text elements. In some embodiments, the computer receives a voice dictation comprising the knowledge and automatically transcribes the voice dictation into the information dataset. In other embodiments, at least a portion of the knowledge is extracted from one or more e-mail or social media data feeds.

In some embodiments, the information dataset is organized into information elements by determining a domain corresponding to the information dataset and identifying the information elements based on domain-specific semantic knowledge structures. These domain-specific semantic knowledge structures may correspond to, for example, (i) a word, symbol, or phrase associated with the domain or a natural language associated with the domain; (ii) a font or a style of formatting associated with the domain; and/or (iii) a numbering or notation style associated with the domain. In some embodiments, the information dataset is organized into information elements by applying artificial intelligence and machine learning to the information dataset to define the information elements.

Some embodiments of the aforementioned method apply machine learning techniques during processing. For example, in one embodiment, a trained machine learning model is used to automatically perform the mapping of the plurality of information elements into the knowledge processes using the knowledge process modeling language. In another embodiment, a trained machine learning model is used to automatically perform the translation of the knowledge process in the business process model language. In another embodiment, a trained machine learning model is used to automatically perform the translation of the knowledge process in the knowledge process model language.

According to some embodiments, an article of manufacture for automating knowledge-based processes and operations comprises a non-transitory, tangible computer-readable medium holding computer-executable instructions for performing the aforementioned method, with or without the additional features set out above.

According to some embodiments, a system for automating knowledge-based processes and operations comprises a knowledge user interface and a knowledge processing computer. The knowledge user interface is configured to receive an information dataset comprising expertise-related knowledge. The knowledge processing computer is configured to organize an information dataset comprising knowledge into a plurality of information elements and map the plurality of information elements into knowledge processes expressed in a knowledge process modeling language. Additionally, the knowledge processing computer is configured to perform one or more of (i) converting the knowledge processes into a knowledge process executable language or (ii) translating the knowledge processes in a business process model language and converting the translated knowledge processes into a business process executable language. In some embodiments, the knowledge processing computer is further configured to use the business process executable language or the knowledge process executable language to automate one or more knowledge-based processes. Additionally, the knowledge processing computer is configured to perform converting of the knowledge processes into a knowledge process executable language. In some embodiments, the knowledge processing computer is further configured to use the knowledge process executable language to automate one or more knowledge-based processes.

The above embodiments also enable the generation of documentation based on the same process leading to a non-variable based document generation system by using a knowledge process converted into a Knowledge Process Modeling Language (“KPML”) and then an Knowledge Process Executable Language (“KPEL”) for the automated generation of a specific case-based document without requiring variables to create automated case based contracts and documents.

Additional features and advantages of the invention will be made apparent from the following detailed description of illustrative embodiments that proceeds with reference to the accompanying drawings.

### BRIEF DESCRIPTION OF THE DRAWINGS

The foregoing features of the disclosure will be apparent from the following Detailed Description, taken in connection with the accompanying drawings, in which:

FIG. 1 provides an overview of a system for automating knowledge processes, according to some embodiments;

FIG. 2 provides an example process for converting knowledge processes in documents into computer executable operations, according to some embodiments;

FIG. 3A provides a portion of an example document that may be received and processed using the techniques described herein;

FIG. 3B shows an example of information elements generated based on the document in FIG. 3A;

FIG. 3C shows an example mapping performed using the information elements shown in FIG. 3B;

FIG. 3D shows a first view BPMN generated using the KPML shown in FIG. 3C, according to some embodiments;

FIG. 3E shows a second view BPMN generated using the KPML shown in FIG. 3C, according to some embodiments;

FIG. 3F shows a third view BPMN generated using the KPML shown in FIG. 3C, according to some embodiments;

FIG. 3G shows a fourth view BPMN generated using the KPML shown in FIG. 3C, according to some embodiments;

FIG. 3H is a drawing showing a graphical user interface of a document having styles;

FIG. 3I is a drawing showing an embodiment of how a document can be organized;

FIG. 3J is a drawing illustrating an example of how a numbering system can organize a document;

FIG. 4A provides an example of KPML processes and sub-processes that may be employed in different embodiments of the present invention;

FIG. 4B provides an example business process flow and its later conversion into a knowledge operation based on standard BPMN processes;

FIG. 5A provides an example of the business process automation procedure, as it may be implemented in different embodiments;

FIG. 5B provides an alternative example of the business process automation procedure, as it may be implemented in some embodiments;

FIG. 6A provides examples of graphical user interfaces that may be utilized to display information about a business process extracted from documents, according to some embodiments;

FIG. 6B provides an additional example of a graphical user interface that may be used in some embodiments;

FIG. 7 provides an example of a full transformation from knowledge document to business process performance, as may be performed in some embodiments;

FIG. 8 illustrates a thin client computing environment in which embodiments of the present invention may be implemented;

FIG. 9 illustrates an exemplary computing environment within which embodiments of the invention may be implemented;

FIG. 10 is a flowchart illustrating processing steps for automatically generating a contract;

FIG. 11 is a drawing of an example graphical user interface for generating an automated contract in the system of the present disclosure;

FIG. 12 is another drawing of an example graphical user interface for generating an automated contract in the system of the present disclosure; and

FIG. 13 is a graph illustrating a machine learning algorithm applied to text in a document.

### DETAILED DESCRIPTION

The following disclosure describes the present invention according to several embodiments directed at methods, systems, and apparatuses related to a Knowledge Process Automation Workbench (the “Workbench”) which enables the end-to-end and full scope automation of knowledge-related work, from knowledge collection and processing to work performance. Additionally, in some embodiments, knowledge-based operations may be automatically performed through a Knowledge Process Building Platform (the “Platform”) which leverages data from the Workbench and enables the performance of the knowledge-based work by the end-user (i.e., client). Briefly, in some embodiments discussed herein, knowledge processes are extracted from documents or input (e.g., automatically, through a kind of AI for knowledge processes, manually, and/or through machine learning techniques). A knowledge process modeling language (KPML) is then applied which, in some embodiments, is enhanced with machine learning for more accurate language information use. Next, the KPML is converted to a Knowledge Process Executable Language (KPEL). Alternatively (or additionally), the KPML is converted into Business Process Modeling Notation (BPMN) (or other business process modeling languages) and transformed into a Business Process Execution Language (BPEL). Thus, a knowledge process can be executed and analyzed on server systems customized for knowledge-based operations (using KPEL) or classic IT business platforms (using BPEL).

The techniques described herein bring automation to professional activities which are currently highly manual due to their knowledge-intensive environments, for the benefit of the end-user and the quality and efficiency of work performance for professionals in the knowledge-based spaces. These techniques can automate all kinds of knowledge processes beyond just specific business operations. Rather, knowledge-based operations are automatically translated into a technology product, from the structured presentation of knowledge and expertise and the understanding of the process to the actual execution of the knowledge process. The techniques described herein may be used to create a master technology tool for all knowledge processes, encompassing knowledge processes' creation and performance. Moreover, these techniques add to conventional BPMN standardized process building by developing a modeling language, herein referred to as KPML, which is particular to knowledge-based content and which enables transformation into a specialized machine executable language for automation of knowledge-based operations. The techniques also enable the automated generation of documents without requiring the pre-determination of a variable based document generation system.

Additionally, in some embodiments, the techniques described herein include the development of server-based systems which enable automated coding of the knowledge processes through a Knowledge Process Executable Language (KPEL). A kind of business AI is developed based on knowledge-based business thought processes and logic for knowledge processes. This business AI is not based on the aggregation of very large amounts of data for analysis (as is generally the case in AI) and natural language processing, but rather, on the precision of the logical structure of knowledge processes and its use in knowledge processes (akin to a mathematics-like structured language), and a detailed identification of the structure of that logic for use in building knowledge processes. Machine learning can, in addition, be applied to this approach for enhanced results.

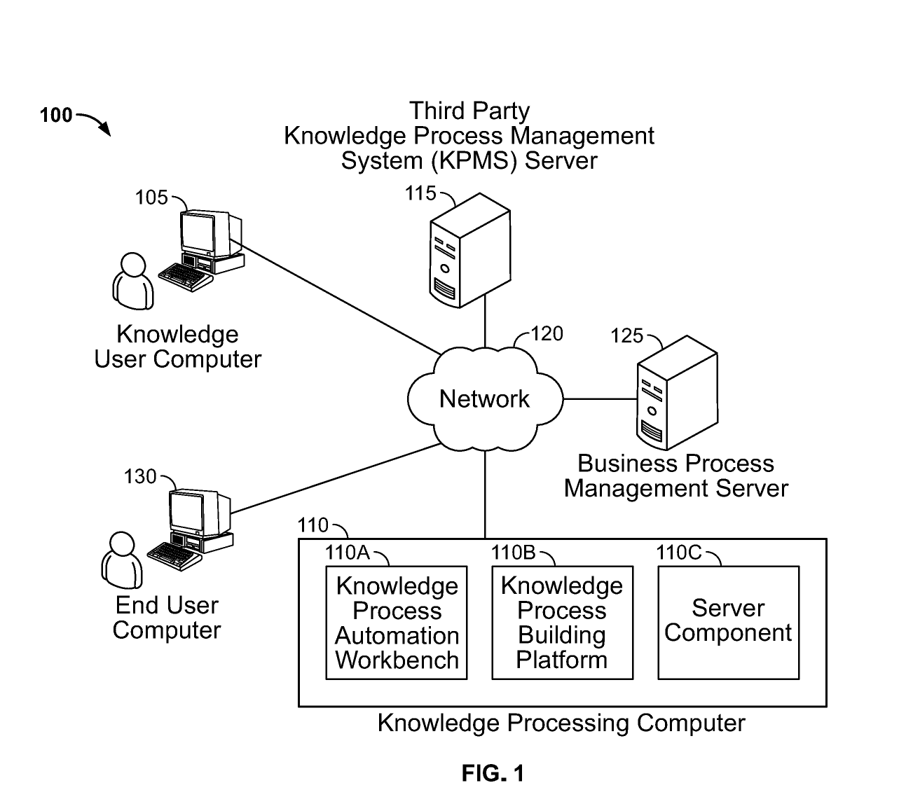

FIG. 1 provides an overview of a system 100 for automating knowledge processes, according to some embodiments. The system 100 includes three principle components: a Knowledge User Computer 105, a Knowledge Processing Computer 110, and an End User Computer 130. Two additional optional computing devices are shown: a Business Process Management Server 125 and a Knowledge Process Management System Server 115. These two Servers 115, 125 may be operated by the same entity as operates the Knowledge Processing Computer 110 or, alternatively, the Servers 115, 125 may be operated by third parties. Each computing device included in system 100 is connected via a Network 120. This network may be any computing network generally known in the art including, without limitation, the Internet.

In FIG. 1, a user accesses the Knowledge Processing Computer 110 via a Knowledge User Computer 105 in order to upload documents and other information to the Knowledge Processing Computer 110, as well as to view and use extracted knowledge processes. The Knowledge User Computer 105 can be any computing device generally known in the art capable of accessing a remote computing resource. For example, Knowledge User Computer 105 may be a desktop computer, a smart phone, or a tablet computing device.

An end user of the system 100 may use an End User Computer 130 to access the Knowledge Processing Computer 110 to view and use extracted knowledge processes. The End User Computer 130 can be any computing device generally known in the art capable of accessing a remote computing resource. For example, the End User Computer 130 may be a desktop computer, a smart phone, or a tablet computing device.

The exact technique for accessing the Knowledge Processing Computer 110 may vary according to different embodiments. For example, if the Knowledge Processing Computer 110 provides Software as a Server (SaaS) type interface, the Knowledge User Computer 105 and/or the End User Computer 130 may employ a web browser to access the Knowledge Processing Computer 110. Alternatively, in embodiments where the Knowledge User Computer 105 and/or the End User Computer 130 is smartphone or a tablet computing device, the Knowledge User Computer 105 and/or the End User Computer 130 may use a specialized app which provides an interface to the Knowledge Processing Computer 110.

Additionally, the exact technique that the Knowledge User Computer 105 utilizes to send documents or other information to the Knowledge Processing Computer 110 may vary. For example, in some embodiments, a graphical user interface (e.g., webpage) may be provided which allows users to directly upload documents to a server for processing and/or collaboration. In other embodiments, users can email the documents to that server (e.g., by including the server as a blind carbon copy recipient when emailing a client or colleague). Additionally, in some embodiments, a program may be utilized to perform a bulk analysis on a large set of documents or other data items. For example, a “crawler” program may be utilized to seek out and process all documents stored on the Knowledge User Computer 105. Moreover, if the Knowledge User Computer 105 is part of a network of computers for a particular organization (e.g., a law firm), the Knowledge Processing Computer 110 can process documents across the collective storage system utilized by the organization.

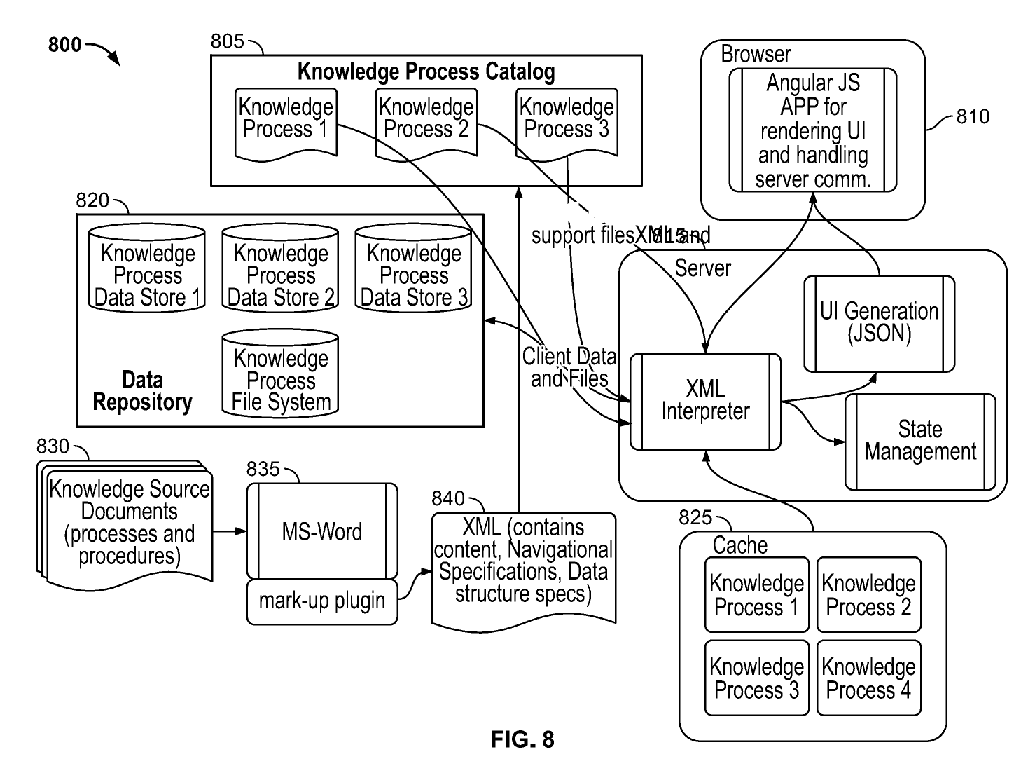

In the example of FIG. 1, the Knowledge Processing Computer 110 is a computer which is configured to extract knowledge processes from documents and information provided by Knowledge Users. As noted above, there are various ways that users can access the Knowledge Processing Computer 110 and similarly the exact architecture of the Knowledge Processing Computer 110 may vary. In FIG. 1, the Knowledge Processing Computer 110 includes a Server Component 110C which provides functionality for tasks such as receiving and responding to user requests. One example of an architecture that may be used to implement the Server Component 110C is shown in FIG. 8. The Knowledge Processing Computer 110 includes two additional components which are related to the processing of knowledge operations: a Knowledge Process Automation Workbench 110A and a Knowledge Process Building Platform 110B. These components 110A, 110B are collections of software elements (e.g., methods, classes, or routines) that provide certain processing functionality, as described in greater detail below.

The Knowledge Process Automation Workbench 110A is configured to provide tools for automated knowledge processes, collection, and organization. In conventional systems, knowledge processes have been processed manually, with professionals sharing their expertise (which can be later translated into automated processes for a specific work or incorporated into expert systems). The Knowledge Process Automation Workbench 110A automates and enhances conventional techniques by collecting, organizing, segregating and qualifying knowledge processes based on professionals' thought processes as they are presented in their work. It is the logical structure of the language and the thought process which is identified as well as, in some cases, the words themselves and their interpretation. For example, a question starting with “should” or “may” does not have the same implication from an operational perspective. One is a compulsory step, while the other is a recommended step. Additional natural language processing and machine learning can be applied for further refinement and understanding of the texts for extraction and organization. A graphical user interface (GUI) may also be added to refine further the results of the extraction and the qualification of the knowledge processes.

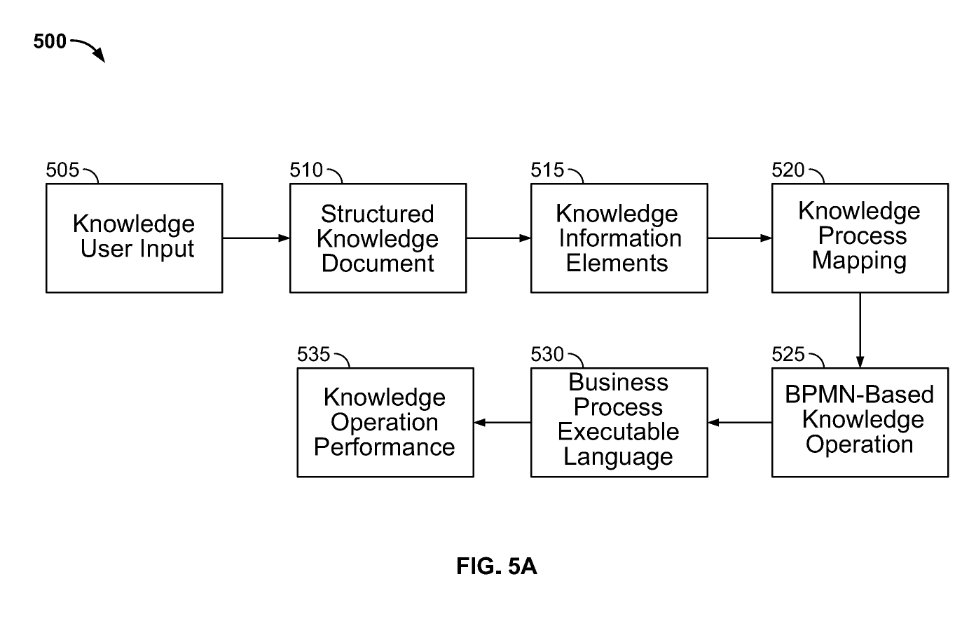

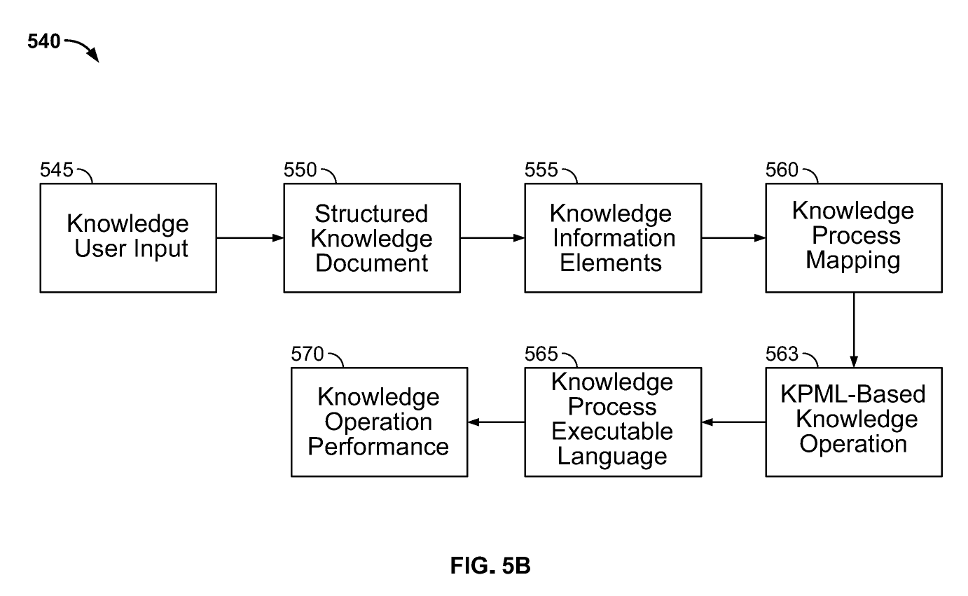

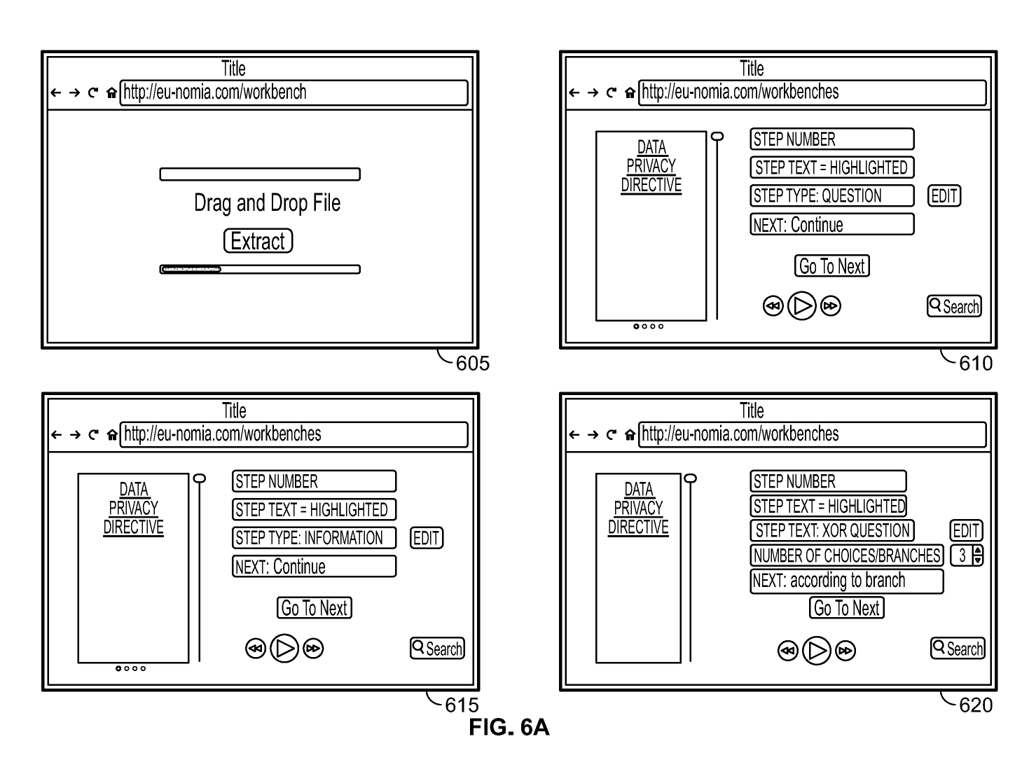

The Knowledge Process Automation Workbench 110A also transforms knowledge processes into dynamic operations through KPML. In conventional systems, the business world has focused on the business process modeling languages especially through the Unified Modeling Language (UML) and BPMN notations. The KPML described herein focuses on knowledge processes not from a business process perspective, but from a knowledge process perspective. By structuring a language for the knowledge space, knowledge processes can be transformed into a computer executable language. The Knowledge Process Automation Workbench 110A facilitates the transformation of the knowledge processes' information elements resulting from the first phase (knowledge extraction and organization) into a dynamic mapping based on KPML language. This process is further described below with reference to FIGS. 5A and 5B.

The Knowledge Process Building Platform 110B is configured to utilize the Knowledge Process Automation Workbench 110A to process different knowledge processes. In conventional systems, knowledge and expertise in the performance of a specific process is manually collected and understood from an operations perspective before being translated into a technology-based specific operation (e.g., bankruptcy procedure, trademark filing, etc.). Based on data from the Knowledge Process Automation Workbench 110A, the Knowledge Process Building Platform 110B enables knowledge processes for any specific knowledge-based operation to be converted into a knowledge process and, by applying KPML, the knowledge may be transformed into a dynamic knowledge-based operation.

In some embodiments, the Knowledge Process Building Platform 110B links the KPML language with the classic BPMN language (or other business process modeling languages) which has been built for business processes. For example in some embodiments, the KPML is compatible with BPMN, while in other embodiments a customized translation tool is used to perform the translation between KPML and BPMN. BPMN language is then converted into BPEL (or other conventional executable languages for BPMN) which are machine readable. The end result is a knowledge-based operation which can be transformed into a machine executable language and enable traditional business process platforms to be enriched and used for knowledge processes automation and execution. For example, in FIG. 1, a Business Process Management Server 125 is shown. This Business Process Management Server 125 may use BPEL generated by the Knowledge Processing Computer 110 to perform knowledge process associated tasks as well as larger business process tasks such as, for example and without limitation, modeling (e.g., performing “what if” analyses), execution (e.g., automating the gathering of client information relevant to a particular topic), monitoring (e.g., the tracking of individual processes), and optimization (e.g., identifying bottlenecks in knowledge processes). In some embodiments, the conversion to BPEL can be done on Business Process Management Server 125.

In some embodiments, as an alternative or supplement to processing at the Business Process Management Server 125, the KPML language is converted to a Knowledge Process Executable Language (KPEL) which is machine executable. This KPEL may then be processed on a Knowledge Process Management System Server 115 which includes functionality specifically directed at knowledge processes. The conversion between KPML to KPEL may be performed, for example, by the Knowledge Process Building Platform 110B or the Server Component 110C prior to transmitting to the Knowledge Process Management System Server 115. Alternatively, the Knowledge Process Building Platform 110B may transfer KPEL to the Knowledge Process Management System Server 115 for conversion. In some embodiments, the KPEL is adapted and used to create a software application for a specific platform such as, for example, Microsoft Azure or Salesforce. Additionally, the KPEL may be adapted to utilize specific features available on the platform. For example, Microsoft's platform may provide interfaces for retrieving text and other data from files in Microsoft-based file formats.

Additionally, although the example described in FIG. 1 references documents, it should be understood that the general concept can be extended to any type of knowledge information. Thus, aside from documents generated by programs such as Microsoft Word®, the documents uploaded by the user may alternatively (or additionally) be in the form of emails, text messages, rich text formats, etc. Additionally, in some embodiments, the knowledge processes can even be uploaded in the form of an audio or video file (e.g., voice dictation). In this instance, the Knowledge Processing Computer 110 may be configured to transcribe information from the audio or file using techniques generally known in the art.

Moreover, although the user initiates the knowledge information transfer process in FIG. 1, in some embodiments, knowledge information may be culled from databases and other resources automatically. This general concept can even be extended to external resources controlled by other entities, provided that the data is accessible. For example, in some embodiments, the Knowledge Processing Computer 110 is configured to collect information published on one or more social media feeds (e.g., Facebook®, Twitter®, etc.) associated with the business. This information may then be processed in a manner similar to a document (as described above in FIG. 1), while taking into account the specific characteristics of the medium.

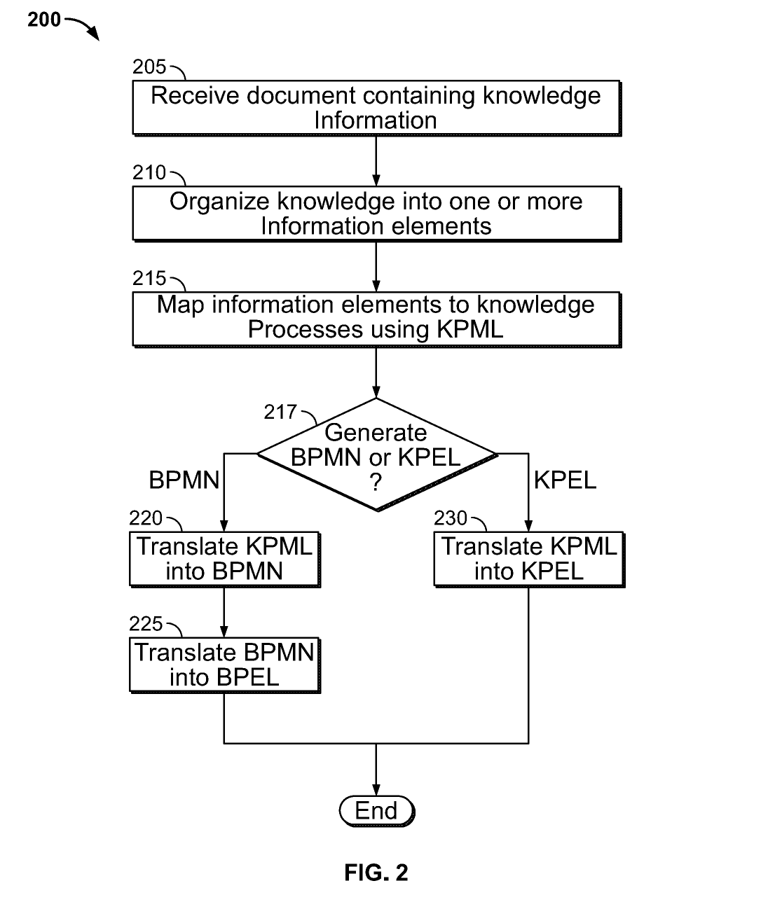

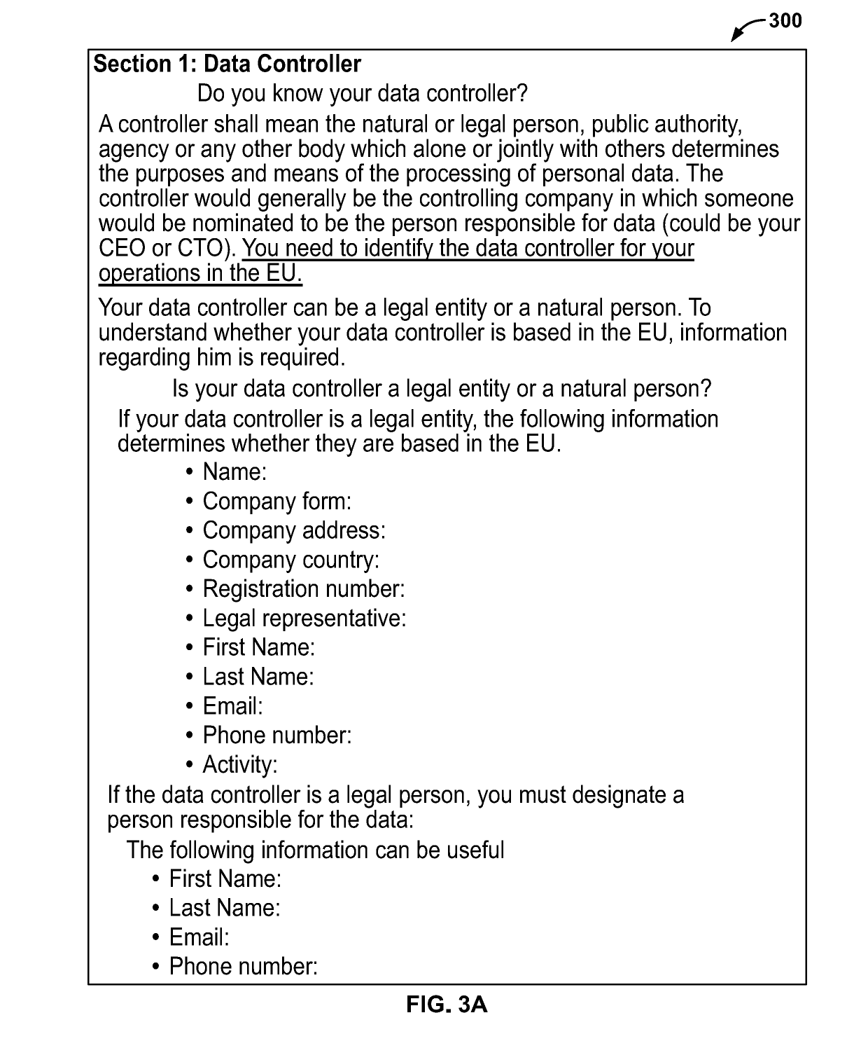

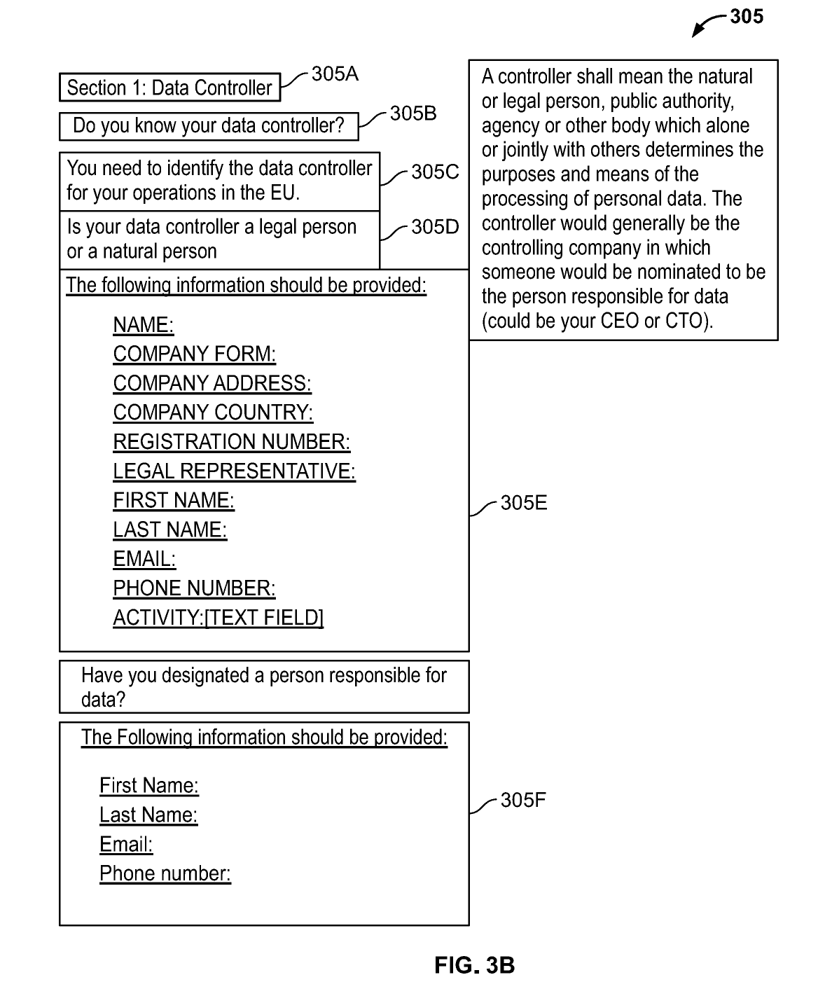

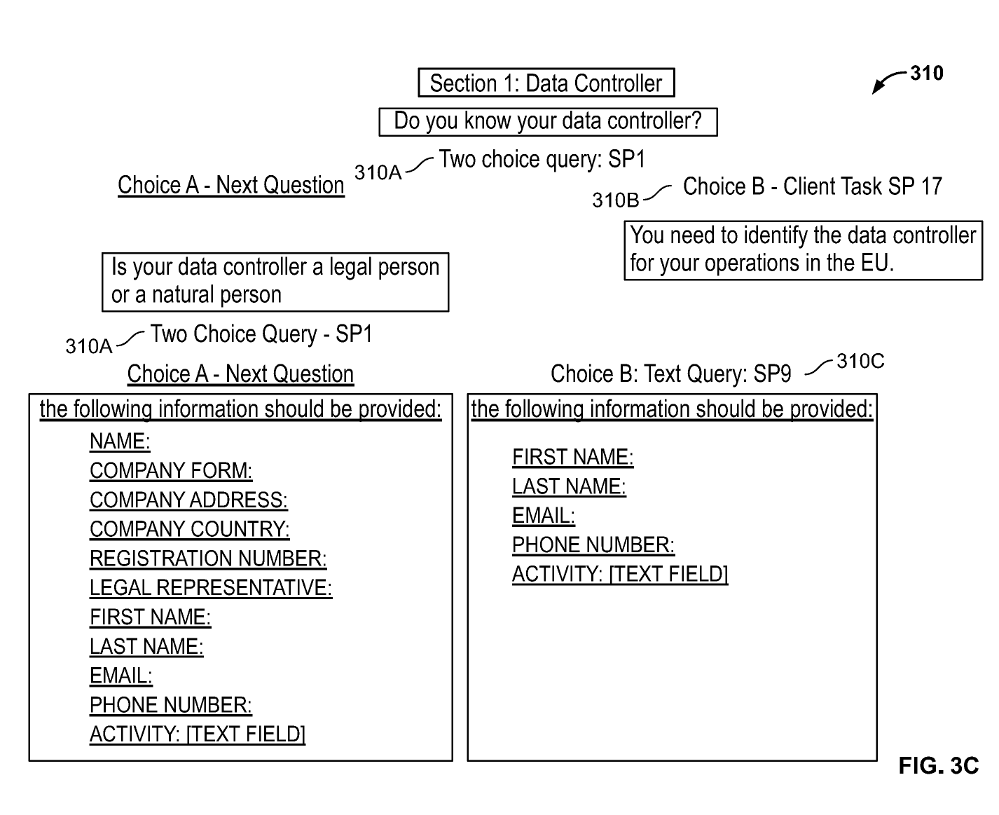

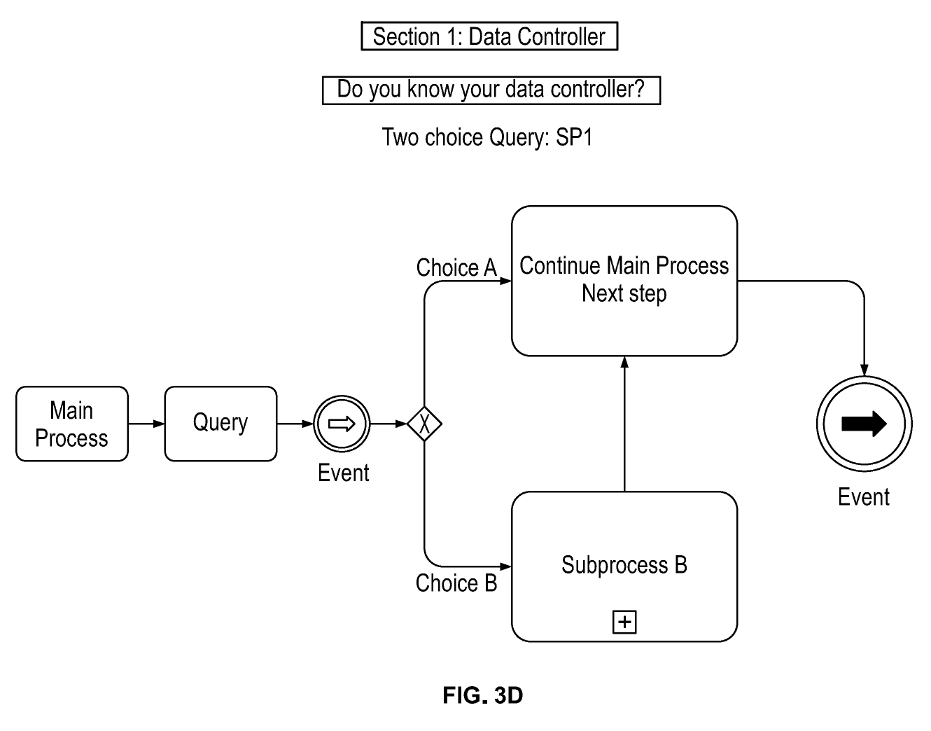

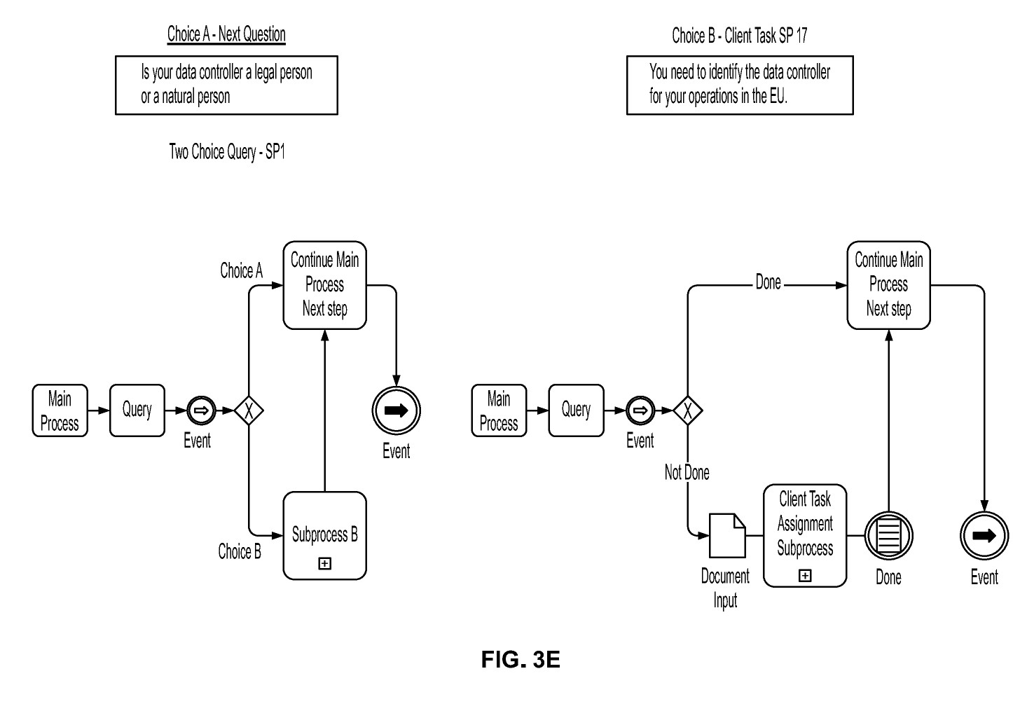

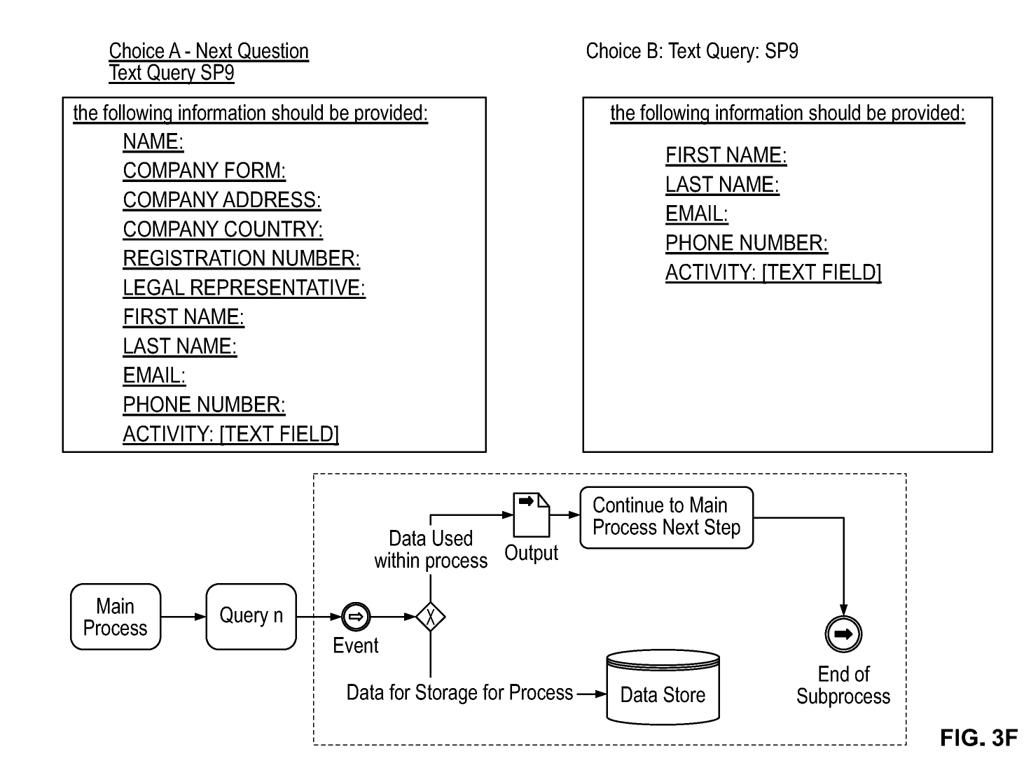

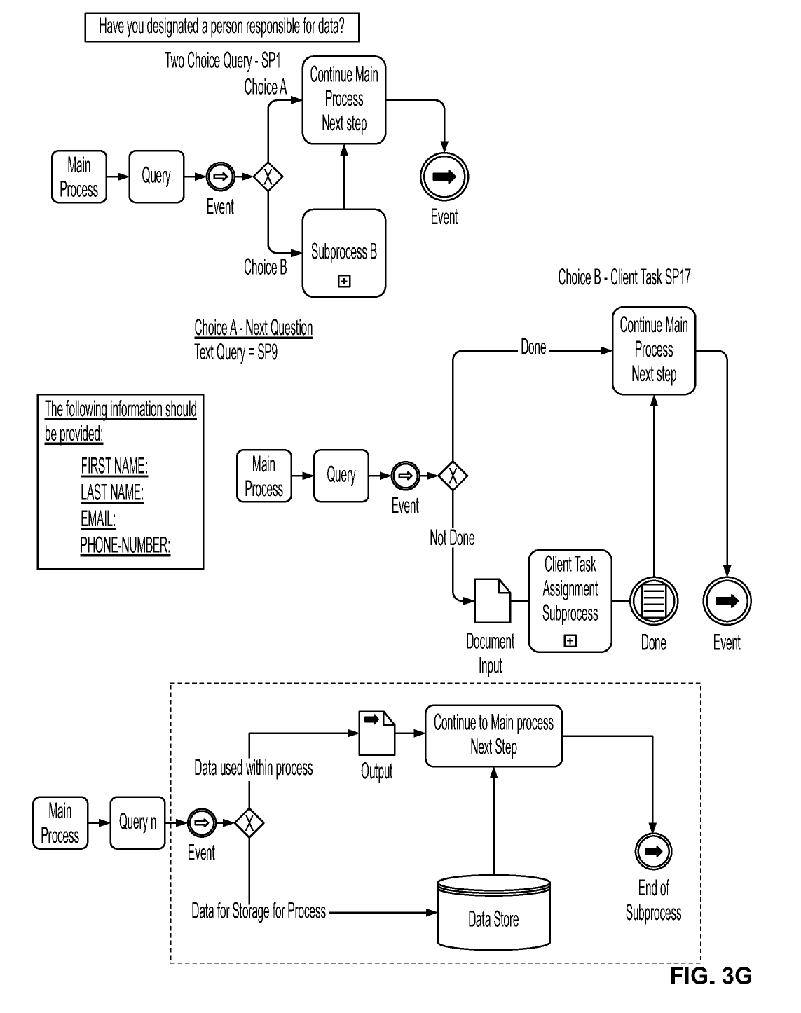

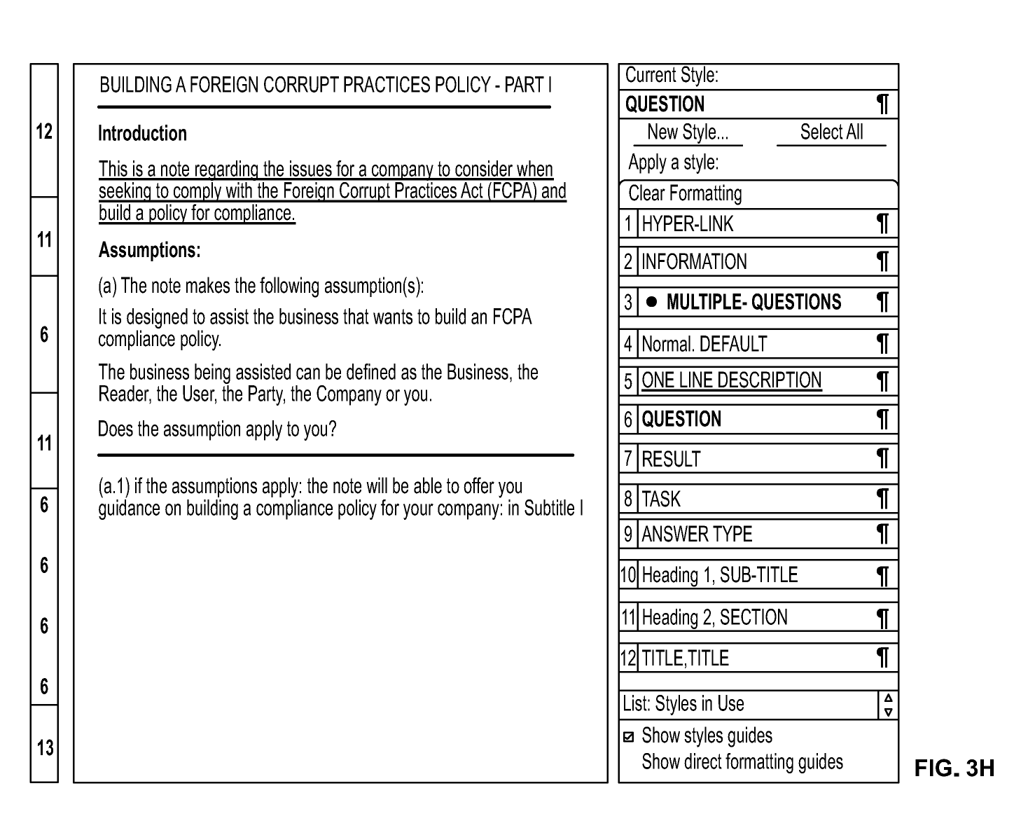

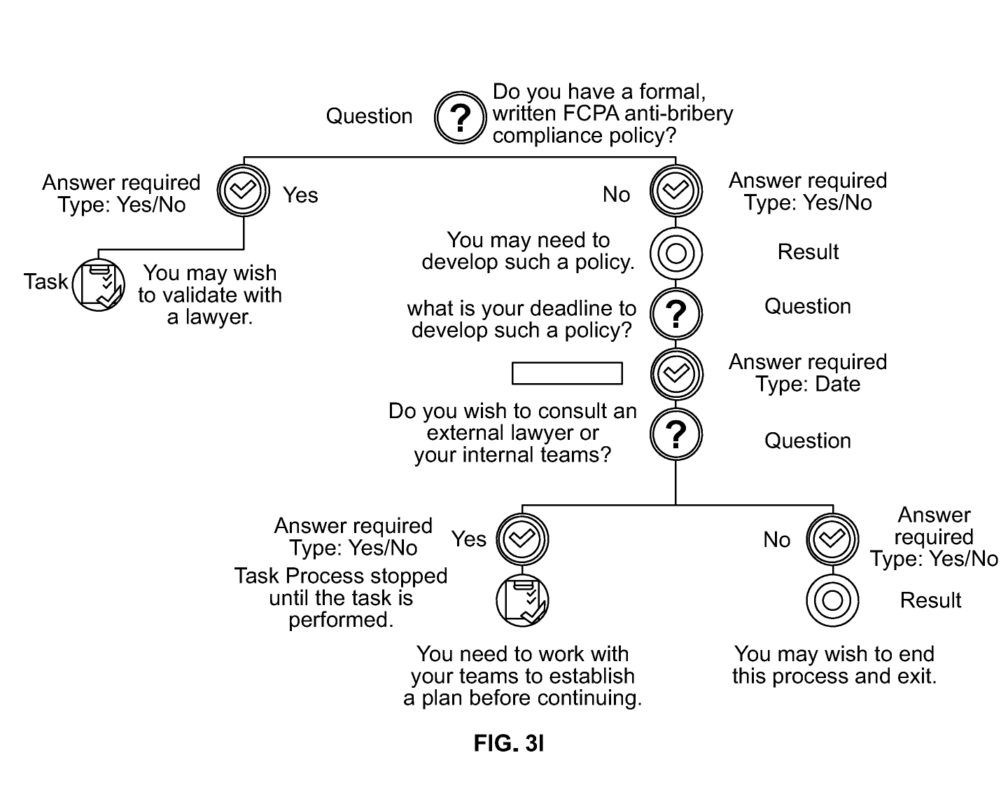

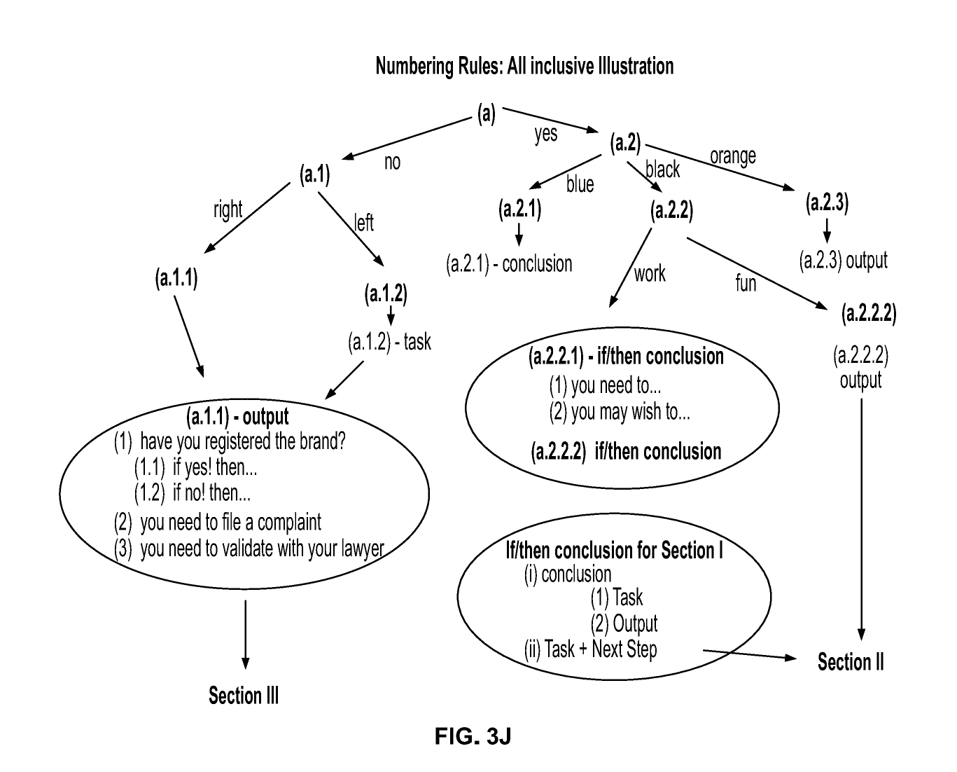

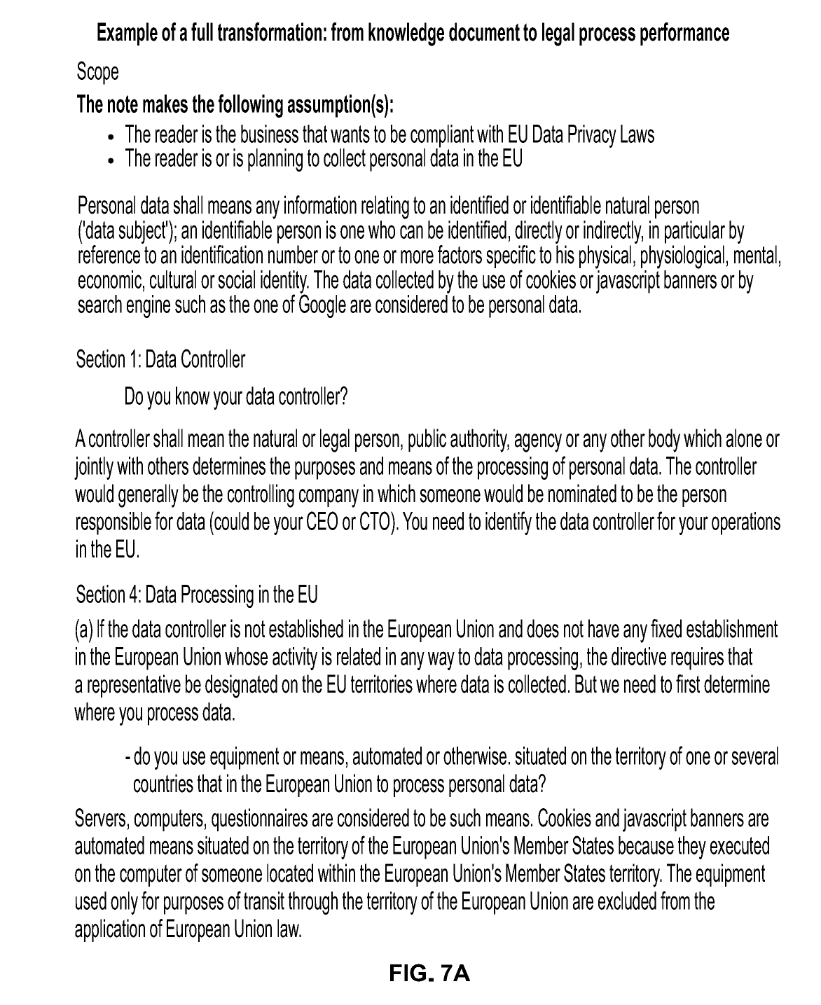

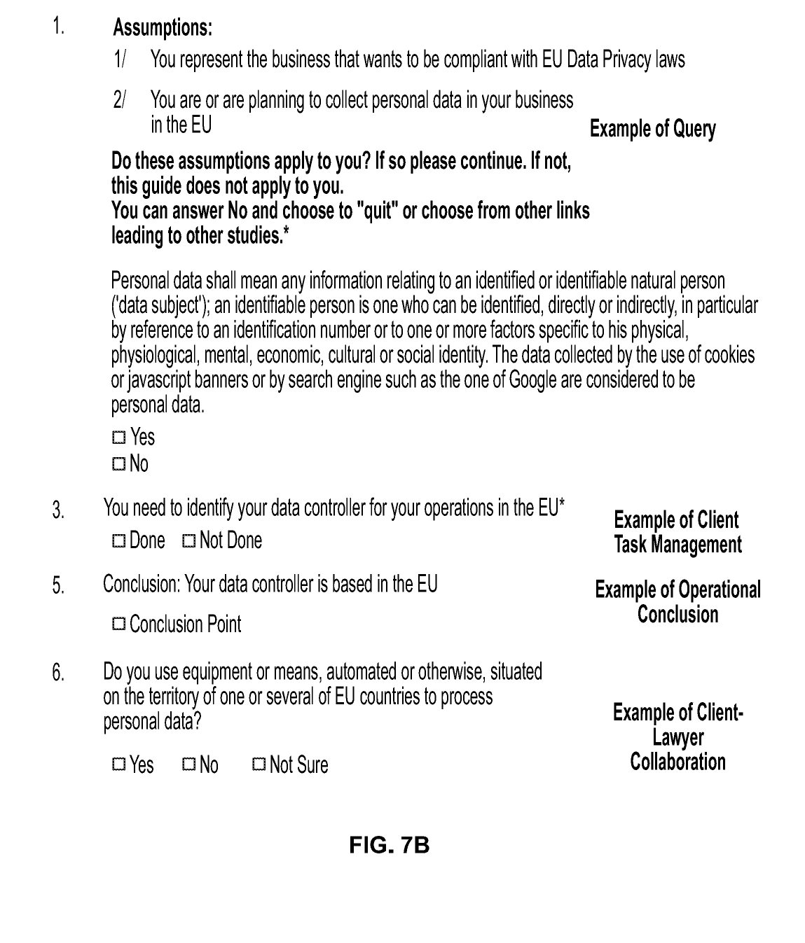

FIG. 2 provides an example process 200 for converting knowledge processes in documents into machine executable operations, according to some embodiments. Starting at step 205, one or more documents are received which contain knowledge information. These documents may be presented in various formats generally known in the art including, and without limitation, Microsoft Office™ (e.g., .doc) formats, html, rich text formats, etc. The techniques for receiving the documents may vary according to different embodiments as described above with reference to FIG. 1. In some embodiments, the documents are either built upon or converted into structured documents (e.g., Microsoft Word rule based documents) to organize the document text in a manner that facilitates extraction in the later steps of the process 200. FIG. 3A provides a portion of an example document 300 that may be received at step 205 and processed using the techniques described herein. This document provides a description of compliance with European Union privacy obligations. Specifically, the document addresses basic questions about a controller. The term controller is defined and some basic information is provided to help a user understand the concept. Then a question is provided: “Is your data controller a legal entity or a natural person”, (either in the form of a question as in the FIG. 3A or in the form of a sentence from which a question is inferred). The question is followed by additional questions and instructions that depend on the user's response. Although question identification is a relatively trivial language processing task and presented here for simplicity, the processing described above may be generalized to more complex information structures as discussed below with reference to FIG. 7.

Returning to FIG. 2, at step 210, the knowledge information contained in the one or more documents is segregated and organized in information elements using automated tagging and extraction techniques coded for the purpose and based on a type of AI for knowledge processes.

Notably, this process may be domain-specific (e.g., specific to the legal domain or the medical domain). For example, the document may be analyzed to detect domain-specific semantic knowledge structures specific to the domain such as known words, symbols, or other indicia of a particular type of text. The simplest example is using the detection of a question mark to designate a sentence as being a question. More complex combinations of words and symbols may also be used (e.g., using the phrase “you need to . . . ” followed by a period to identify a task to be accomplished). In general, the document may be structured to follow domain-specific thought processes and their logic based step-by-step approach. The document also allows for identification of the kind of knowledge it contains: information, questions for which a professional working in the domain would require answers to draw conclusions and next steps, tasks a user would need to perform for a business operation.

Specific fonts and formatting indicative of these specific kinds of text may also be used as the basis for domain-specific semantic knowledge structures. For example, a multiple answers question may take the form of bullet points or an important task to be performed may be presented in a sentence underlined in the body of a text. Once generated, the information elements may be presented visually, for example through a GUI, to allow for ease of use and validation processes (e.g., via drag and drop operations or as an automated presentation for validation). The system of the present disclosure can generate an automated validation system as well as an automated user-interface for execution of the knowledge process. Based on the user's validation of the document, machine learning rules can be learned or updated to aid in the processing for additional documents and natural language processing can be used for refining the result. For example, FIG. 3B shows an example of information elements 305 generated based on the document 300 in FIG. 3A. In this example, six elements of knowledge processes have been identified: 305A, 305B, 305C, 305D, 305E, and 305F. The system of the present disclosure can be implemented with the use of the KPML and the KPEL. Alternatively and/or independently, the system of the present disclosure can also include the use of the BPML. Alternatively and/or independently, the system of the present disclosure can also use BPML to create a KPEL.

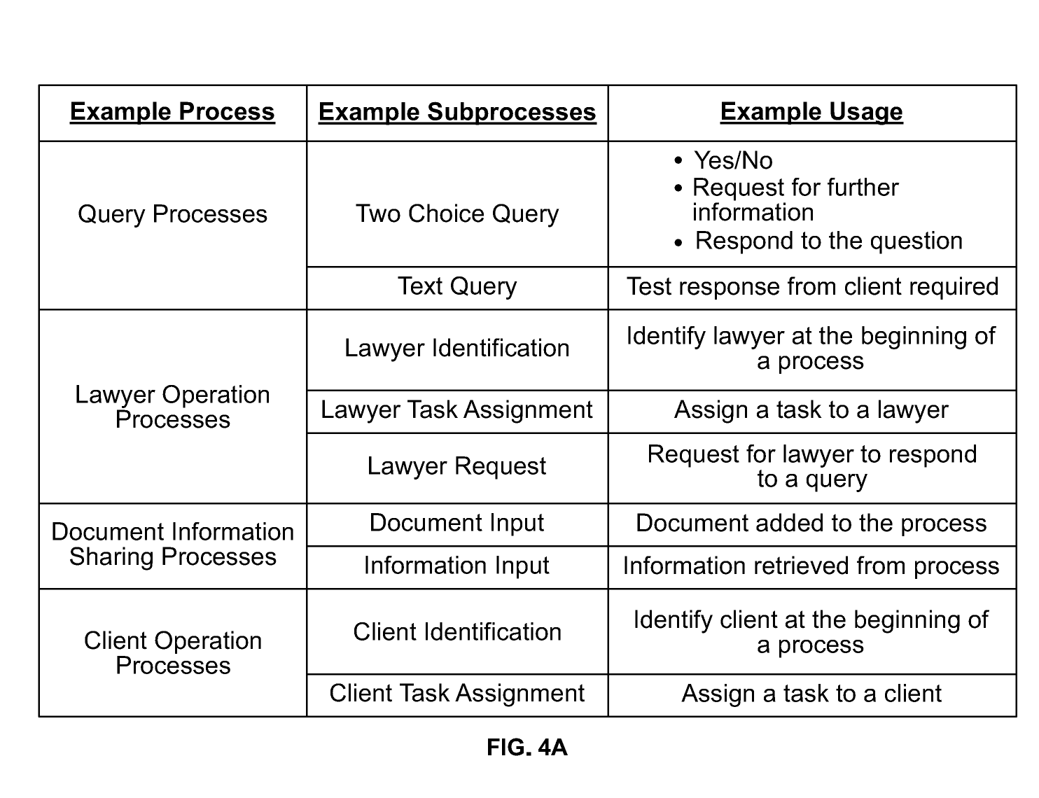

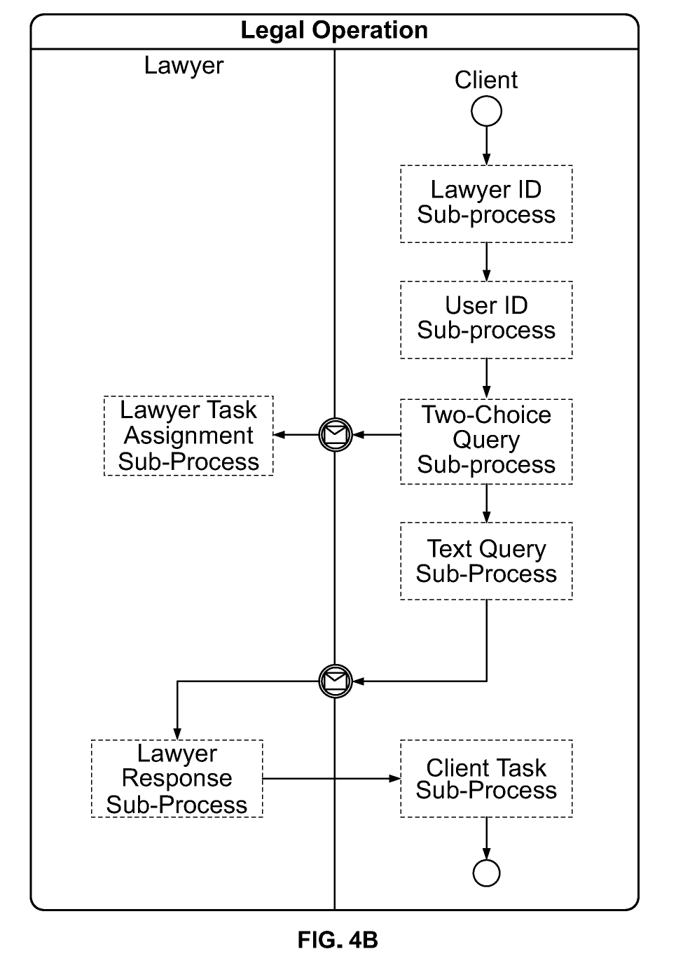

At step 215 in FIG. 2, the information elements are dynamically mapped to one or more knowledge processes. This is generally an automated process that creates links between different elements of the diagram for identifying and building knowledge processes. Additionally, in some embodiments, the dynamic mapping may be semi-automated if the information is not available in the initial document and needs to be added manually. The links in the mapping are based on KPML which, as described above, is a language developed for the purpose of knowledge processes standardization. In the simplest case, the links may be generated based on one or more semantic rules. For example, a statement ending in a question mark and containing the word “or” may be classified as two-choice query; while a statement with the phrase “you need to . . . ” may be classified as a client task. In some embodiments, these basic semantic rules may be used applied by a machine learning model to allow more complicated links to be identified based on the semantic data in the information elements. In some embodiments, a GUI or other tools may be used to refine KPML to create customizations for the knowledge process. Any customizations presented by the user via the GUI may be used to further train the model and provide more refined links in future mapping applications. FIG. 3C shows an example mapping 310 performed using the information elements shown in FIG. 3B. In this case, 3 types of KPML sub-processes have been developed: Two Choice Query 310A, Client Task 310B, and Text Query 310C. Additional examples and details on KPML are provided in FIG. 4.

The system of the present disclosure can handle processing of an entire document, not just discrete sentences or portions of a document. As will be explained in greater detail below, the system can tag information elements with information that provides a context and location of an information element with respect to other information elements. The system can also tag the document with information which can hold any knowledge based content and the system will apply to it as described herein. Moreover, a conversion language can further identify location of information elements and create a flow of the information elements in an entire document. These processes, among others, can allow the system to process an entire document which allows the system to understand the relationship of all the information elements with each other.

A conversion language can also be used to further automate and enhance the processes of the present disclosure. As noted above, the system of the present disclosure can classify and tag a document based on a number of factors as discussed above. The conversion language of the present disclosure can additionally and/or alternatively tag information elements in a document and also identify a location of the information element in the document. Additionally or alternatively, system can classify a title, subtitle, section, sub-section, normal, and/or default as structural styles and portions of a document. The system can also classify and/or tag a question, multiple-question, answer, answer type, result, task, and/or conclusion as content styles or portions of a document. In particular, the system can tag information elements with information relating to the position and the part of a document where the information element can be found. This way of tagging creates a rich baseline for the system to handle machine learning, and conversion of the document to executable languages as will be described in greater detail below. The system can also classify and/or tag a note, information, and/or hyperlink as additional formatting styles and potions of a document. This styling of a document can allow the collecting, extracting and qualification of the information elements which are the components of the knowledge work. This information can be converted into information elements with their qualification (question, answer) and their associated behavior (e.g., an input required for a question, an output resulting from an answer). The system of the present disclosure can fully automate this process using computer code and machine learning algorithms. The styles can be implemented with artificial intelligence and machine learning which allows for identification of the different information elements and their qualification. By analyzing a large dataset of the documents built with the styles, the system can identify the content of the information and to automatically qualify the information elements. An example graphical user interface showing various styles of the present disclose is illustrated in FIG. 3H. As can be seen on the right-hand side, a styles pane can be provided showing the various styles that can assign to various portions of a document on the left-hand side. The number corresponding to the style can be displayed as can be seen on the far-left margin of the graphical user interface. FIG. 3I illustrates the benefits of the system applying styles to a document. The system can automatically arrange a word document in the tree structure shown in FIG. 3I. Accordingly, the tagging of the present disclosure can tag information with respect to the structure of the entire document and taking into account the various sections and styles of the document.

The conversion language of the present disclosure also includes a numbering system for creating links between various information elements of a document. The numbering system creates a flow structure between the information as can be seen in FIG. 3J. This allows the identification of both a relationship (a question and its sub-questions or results related to a question) as well as the identification of the location of the next step to create a flow. As can be seen in FIG. 3J, if information element (a) relates to a question, information elements which are answers a.1 and a.2 can be linked to element (a). The tree structure as shown allows the system of the present disclosure to traverse through the information elements which gives the system a greater understanding of a document. Depending on the answers a.1 and a.2 additional information elements can be linked to a.1 and a.2. The conversion language can include a flow for all of the information elements in the document, not merely just discrete sentences or portions of a document. Each information element can include a clause or sentence, and further can include a plurality of clauses or sentences should there be a relationship among the clauses or sentences. Accordingly, the conversion language can create of flow and represent a relationship of all the clauses in a document with respect to each other.

The conversion language of the present disclosure can also enrich and analyze sentences in a document which can resolve conditional situations and clauses. One example can be in an sentence that includes an if/then clause. A sample format which can be used is if [client's choice]:[answer sentence presented to your client]:[next part of process to which your client will be taken]. Another format can be if [this is your choice]:[this is what it means for you]:[your next action is set up in this part of the document]. If the clause after the second colon is not present, then the system can understand that the client of the document can continue the process without indicating where the reasoning will proceed. If the clause after the first colon is missing, then the system need not provide feedback to the user. Also, if the only clause after the colon is to “continue” then the system can take the next step. The structure of the sample format allows the system to automatically identify the three parts of a sentence and extract them as three parts of a conditional. The system can then convert the parts of the sentence into a question needing a conditional response, a choice of answers displayed, and an outcome. These parts can be displayed and represented as a flow based on an indication of the location for the flow. This method of analyzing a sentence can parse an example sentence in the following way: if [you like sunshine]: [you enjoy summer and may wish to look at boating in the summer]: [in Section 2].

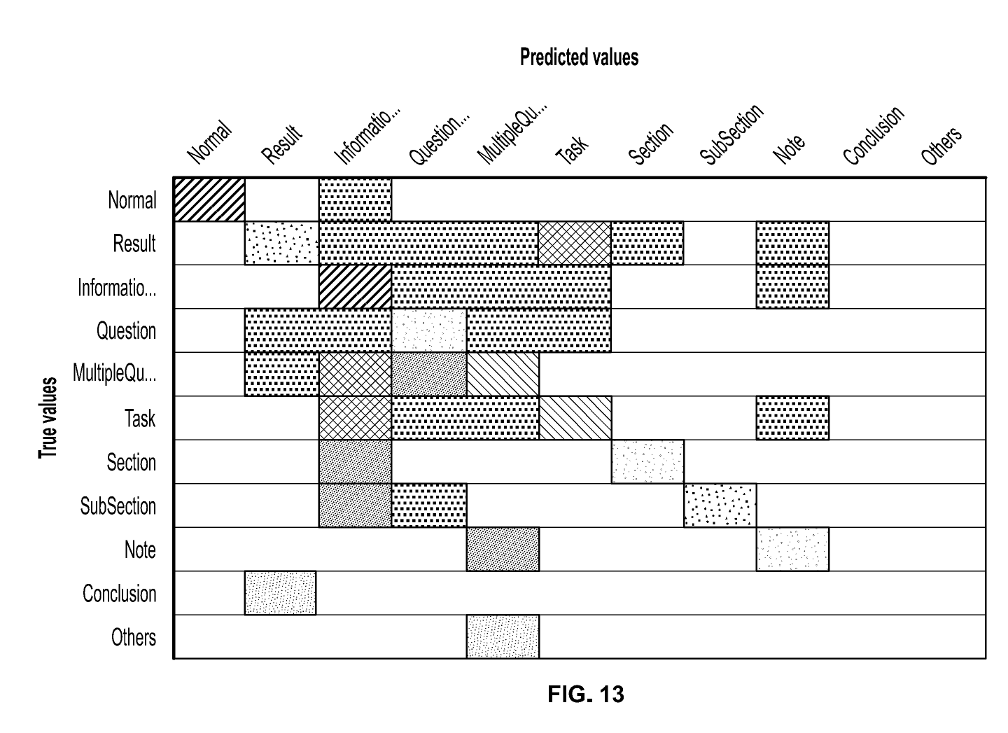

The system can identify any word through machine learning and computer logic and turn that word into a computer function. FIG. 13 is a graph illustrating machine learning as applied to text in a document. For example, phrases such as “you must,” “you should,” or “you need to,” can correspond to a task for a person to perform. Also, phrases such as “you must not,” “you should not,” or “you need not,” can correspond to tasks that a person should not perform. Also, phrases such as “you may want to,” “you may wish to,” or “it is useful to,” can correspond to tasks that it is recommended for someone to perform. The system can recognize these phrases, and many more, to turn words in a document into functions and actions for the system to perform. If a lawyer, counselor, attorney, or advisor is associated with the above tasks, the system can recognize that an expert can be (or may not be if “not” is present) required to perform such tasks. Moreover, if the word “validate” is used with the above phrases, the system can interpret that the task needs to be validated (or not if “not” is present) by an expert. If the structure of a sentence is such that the phrase “before continuing” appears with the above phrases, the system can interpret the sentence to require a task (or not if “not” is present) before continuing a process. A person of ordinary skill in the art would understand that a computer can be programmed to process any combination of phrases. For example, if “before continuing” and “validate” and “lawyer” appear together, then the system can understand that a task can be validated by an expert before continuing in the process. As can be seen in FIG. 13, the true values of the information elements match with the predicted values of the information elements to allow for a enhanced document by the system. FIG. 13 further shows how machine learning can learn to identify types of information, which independently and/or alternatively can be identified by styles. The system can then automatically extract the information identified and recognize the type of content (e.g., information/conclusion/result) as shown in FIG. 13. The system can then associate the treatment that type of content is to be given while generating the contract. The system can use machine learning to recognize the content of the document (without even using styles) and extract the knowledge and work through the system of the present disclosure. Machine learning can also work on contracts so that the system can understand clauses in the contract and further prompt a user to determine whether the clause can be accepted, refused, or edited. The contract can be built by iterating through this process.

The system of the present disclosure can also interpret words to signal a navigational instruction. Accordingly, specific words can also be identified to lead to an automatic conversion into specific executables (functionalities). For example, “please continue” can mean to continue the process. The system can have the process automatically go to the next step without identifying this word, but many documents include such a phrase because it is user-friendly. If the system finds the words “go to,” the system can the move the process to the appropriate section following the words “go to.” The system can choose not to present an answer before a client is brought to the new section. For example, the sentence if “you like sunshine: go to Section 1” can prompt the system to bring the client automatically to Section 1.

The system can also determine the end of a process with a number of keywords. For example, if words such as “quit,” “end,” “exit,” appear near “process” or “execution” the system can exit or can provide a exit button to a user. These words and sentences can in other embodiments be expanded by the use of artificial intelligence and machine learning to enhance the capabilities of identifying words and language. Similarly, artificial intelligence and machine learning can be used to enhance automation for a larger amount of knowledge work. Additionally, the knowledge process automation can include other non-knowledge based work based on the same design, by adding for example tasks which lead to automated business processes and robotic process automation.

As noted above, the system of the present disclosure can perform the conversion language and other processes of the present disclosure through the use of machine learning. In addition, the system can be programmed with various rules for performing the conversion. For example, the system of the present disclosure can identify various items using styles as discussed above. The system can also rely on other means for analyzing a document to determining information elements in the document. For example, titles, sub-titles, sections, and sub-sections, have unique relationships in that they might be centered, have different fonts, not within paragraphs, etc. The system of the present disclosure can use context clues within a document to determine the information elements. The system can automatically identify and tag information elements without requiring any manual tagging or identifying of variables.

Once information elements are determined, the system can take into account a number of rules that correspond to the information element. For example, a title can indicate the title of an advisory process. A sub-title can indicate part of a process representing one theme, or groups of sections that work together around the same theme. A section can indicate a part of the process that deals with particular logical question and answers that leads to conclusions. A sub-section can be part of a section used to further specify themes within a section. A question can be easily identified with the use of a question mark or styles as discussed above, and can indicate a question being asked to a user of the document. Multiple questions can indicate a series of questions which can have a relationship with each other and can be closely linked. For example, a series of questions can be directed to solicited a first name, last name and email.

A result can be a comment or advice to be given to a user of the document which can be in response to a question. A conclusion can be input or advice to a user based on the user's responses to questions and expertise provided by an expert or programmed within the system. The system can determine a need for a conclusion, for example, with the following phrase providing a context clue: “if, based on your response.” The system can identify other phrases with similar meaning as well. A task can also be identified by a style or certain phrases which can indicate something a user is called upon to do, and the system can input such a task in a electronic calendar of the user for the user's convenience. A normal,DEFAULT style can be a separator which can be text that has no impact on the final application. It can be added after multiple questions format or between two results or between two conclusions. A note style can indicate important information such as the document or application's purpose. The note can appear by default in the final application. Optionally, it can be chosen for the note not to appear in the application. An information style can be any material that the system can deem necessary to inform the user of the document when going through the document or application and which can be ascertained after the user answers questions. Information can appear in the final application. A hyperlink can also be identified by the system as a style or with context clues as to the format of the hyperlink. The hyperlink can indicate a website or an external source that the user of the document may want to consider or refer to while going through the document. The system can also include a document via the hyperlink for the user of the document to consider.

Answer type is another style or information element that can be identified by the system of the present disclosure. This allows the type of response that can be needed from a user of the document. One example of presenting an answer type is by a parenthesis. Another example can be a list with a description of the kind of answer that is wanted. Another can be a list of the possible answers. Some possible answers, include, but is not limited to, dates, times, phone numbers, emails, numbers, numbers with units, etc.

The KPML can be turned into an executable language using natural language processing elements which enable the dynamic mapping of the process between different elements as well as location of the elements on the document. This enables the automated execution of the process as described in the present disclosure. For this, the method can associate each information element with a location in the word document. The method can also tag the content based on the KPML, and a word-based conversion system and a flow direction for the execution using location. By tagging information elements, and by organizing each information element to a specific location (as discussed above), the KPML can easily and automatically be converted to a executable language as the process flow is already laid out. The conversion language accordingly reduces processing time by allowing the conversion of the KPML to the executable language to be done with significantly less computing resources. The conversion language obviates the need for manual dragging and dropping assignment of styles. The conversion language of the present disclosure also improves upon automated document conversion methodologies because prior systems analyze information elements in isolation and then later commit processing power to reengineering how a single information element may be related to another information element. The design of prior systems would require many iterations and exponentially significant processing power to continually resolving the relevancy of an information element to another element in a document. The system of the present disclosure, in contrast, considers and analyzes the location of information elements and how they are organized in a document in conjunction with determining the type of information element and the flow of information elements in the document. This unique system can lead to greater efficiencies in converting a document into an executable language and can provide a system and machine learning algorithms a greater understanding of a document and its meaning. Accordingly, the executable language of the present disclosure provides the benefit of providing greater computer functions that could not before be realized. Moreover, documents are largely text based, so the conversion language reduces processing because the constant transfer of text information in prior systems was inefficient, whereas the current system uses the conversion language to convert the KPML to the executable language thereby obviating the need to handle large amounts of data.

The system of the present disclosure also can include a manual intervention function to introduce variables. In particular, certain information elements or variables can be introduced based on expert analysis. As noted above, the information elements do not need to be manually identified as the system can automatically identify the functions as discussed in greater detail above. However, in some cases expert analysis can reveal additional information elements that were not disclosed in the document. These elements can be added to any part of the process of the system of the present disclosure.

Returning to FIG. 2, at step 217, a selection is made between generating BPMN (or other business process modeling languages) or KPEL based on the KPML. This selection may be performed, for example, by the user at runtime or using a pre-configured setting. If the BPMN option is selected, the KPML generated at step 215 is translated at step 220 into BPMN standard business sub-processes. This translation may be performed, for example, using a mapping between KPML and BPMN. FIGS. 3D—3G show examples of BPMN generated using the KPML shown in FIG. 3C. Next at step, 225, one or more tools generally known in the art may then be used to convert the BPMN into BPEL or some other form of machine executable operations. Alternatively (or additionally), if the KPEL option is selected at step 217, the KPML generated at step 215 is translated into KPEL at step 230. The end result of the process 200 is an end-to-end and full scope automation tool for any knowledge-based operation or even any simple business operation, and a platform which enables automated knowledge-based work performance.

For further enhancement and automation, sub-processes can be developed. The sub-processes can be employed as an alternative to the conversion language and can be applied with the conversion language. FIG. 4A provides an example of KPML processes and sub-processes that may be employed in different embodiments of the present invention. The example of FIG. 4A, along with other examples presented in this disclosure, illustrate application of the disclosed techniques in the context of legal knowledge. However, it should be understood that, in principle, the techniques described herein may be extended to any type of knowledge-generating workflow such as, for example, medical diagnostics or financial advice. Four basic processes are shown in FIG. 4B: query processes, lawyer operation processes, document information sharing processes, and client operation processes. These basic processes, and their related sub-processes, may be combined and linked together to form a complete process flow and are (i) translated into BPMN sub-processes and flow modeling and/or (ii) KPML based sub-processes and flow modeling, both options leading to their specific executable languages. For example, FIG. 4B provides an example business process flow and its later conversion into a knowledge-based business operation based on standard BPMN processes, some of which are illustrated in FIG. 4A.

FIG. 5A provides an example of the knowledge process automation procedure 500 in a business context, as it may be implemented in different embodiments. Knowledge User Input 505 comprising knowledge information is provided by a business user. This Knowledge User Input 505 is converted into a Structured Knowledge Document 510 (i.e., a document where the information is structured). Next, extraction is performed, for example, through specific coding and/or visual presentation. Additionally, the extraction may be enhanced with machine learning capabilities for refined presentation and understanding of extraction. The extraction results in Knowledge Information Elements 515. KPML is applied to the Knowledge Information Elements 515 to provide a Knowledge Process Mapping 520. In some embodiments, the application of KPML may be enhanced with machine learning for more accurate language information use. The KPML in the Knowledge Process Mapping 520 is converted into a BPMN-Based Knowledge Operation 525. The BPMN-Based Knowledge Operation 525 is converted by an IT platform (e.g., a conventional business process platform provided by Oracle, SAP, IBM, etc.) to BPEL 530. This BPEL 530 may then be used to perform an automated knowledge process for end-users, resulting in Knowledge Operation Performance 535.

The table below illustrates some categories of examples of knowledge operation performance that may be automated using the procedure 500:

TABLE 1

| Process | Knowledge Operation Performance |
|---|---|
| Legal recommendation | Client decision to carry out a specific business |
| | operation based on lawyer knowledge and |
| | analysis |
| Business operation | Client business operation performance, for |
| | example, in the human resource domain |
| Regulatory compliance | Client validation of a regulatory compliance |
| | requirement |
| Medical diagnostics | Client identification of a potential disease or |
| | condition based on their symptoms and signs |
| Business operation with | Client led business operation performance |
| interactive client task | |
| management | |

For example, a regulatory compliance process would ordinarily require a manual review of knowledge and information pertaining to the process presented for example in a document, and a manual identification of one or several particular regulatory requirements which need to be complied with. A user would then need to manually check whether these regulatory requirements can be met by the organization and, if so, submit confirmation to the requesting party. By converting the process to KPEL, these steps may be entirely automated by automatically identifying the compliance requirements in the process presented in the document and structuring the process in a machine readable way such that they can either be clearly requested as a mandatory requirement to be carried out to ensure compliance or even be used in other tools to automatically query existing knowledge databases to confirm that the regulatory requirements can be met. Thus, the user is potentially eliminated from the process altogether. However, for some processes, it may be desirable for the user to provide some level of validation that the process is generating correct results before, as well as expertise validation of results.

FIG. 5B provides an alternative example of the process automation procedure 540 in a business environment, as it may be implemented in some embodiments. Items 545, 550, 555, and 560 are similar to items 505, 510, 515, and 520, respectively, of FIG. 5A. Thus, Knowledge User Input 545 is provided in the form of a structured word document. Alternatively, this Knowledge User Input 545 is converted into a Structured Knowledge Document 550 and extraction is performed to generate Knowledge Information Elements 555. KPML is applied to the Knowledge Information Elements 555 to provide a Knowledge Process Mapping 560. In contrast to FIG. 5A, in the example of FIG. 5B, KPML in the Knowledge Process Mapping 520 is converted into Knowledge Process Executable Language 565, resulting in a KPML-Based Knowledge Operation 563. This Knowledge Process Executable Language 565 may then be used to perform an automated knowledge-based process for users, resulting in a Knowledge Operation Performance 570. The categories of knowledge operation performances that may be generated using the procedure 540 in the business space are similar to those presented in the table above with respect to FIG. 5A.

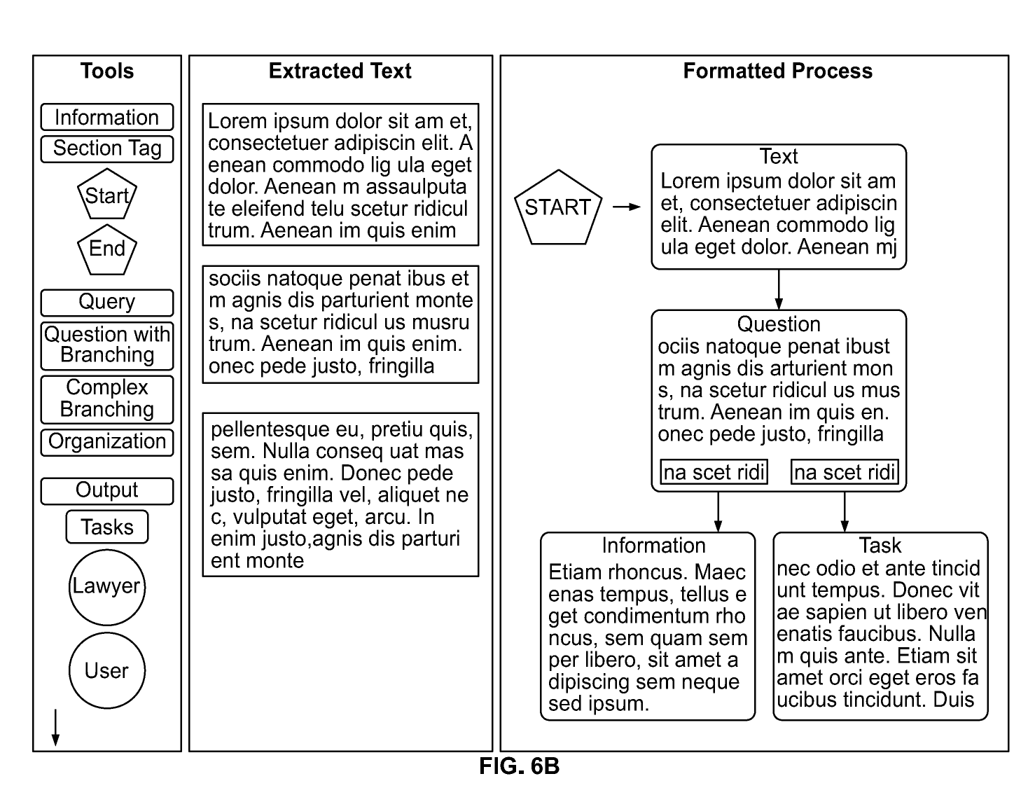

FIG. 6A provides example GUIs 605, 610, 615, 620 that may be employed in various embodiments for displaying relevant information regarding the knowledge process, as gathered and developed using the techniques discussed above with reference to FIGS. 1-5. These GUIs 605, 610, 615, 620 enable the visual validation of automated transformation from initial document to information elements and process mapping before final step of automated application of executable language and creation of the knowledge process for use by the end-user. This can also be automated as the whole process can be automated from validation through workflow display.

FIG. 6B provides an additional example of a GUI that may be utilized to display information about a knowledge process extracted from documents, according to some embodiments. As noted above, this process can also be automated from validation through workflow display.

FIG. 7 provides an example of a full transformation from knowledge document to knowledge process performance, as may be performed using some of the techniques described herein. More specifically, this example shows the transformation of the knowledge processes document into an “app like” product and the final user-facing result of the whole operation transforming the document into a knowledge-based operation performing app.

The techniques described herein provide many benefits over conventional systems. For example, these techniques bring advanced automation to professions and activities which are highly manual due to the high level of knowledge work involved and allow these professions and activities to build efficiencies in their work. They benefit both the professionals, and their clients and end-users looking for streamlined advice or performing knowledge based operations. Thus both the knowledge-users and professionals and the end-users can benefit from efficiencies through the automated creation of knowledge processes and their computer-based execution. Moreover, the techniques, as based on the actual business and professional environment work habits create automated machine executable operations without disrupting the professionals' work environment, enabling easy adoption by them. The techniques described herein are also easily adopted by clients and end-users as a stand-alone tool and platform or as integrated into the client's business environment, as they can link themselves to classic business process platforms (e.g., provided by Oracle or SAP) in order for the end-user and client to perform the automated knowledge processes. The end product for the final user/client is also extremely simple and easy to use as it can take the form of an application in a cloud environment or a software application on a user's device (e.g., a smartphone app) and can be built and accessed on traditional business apps platforms such as Microsoft Azure™, Force.com™, and Apple's CloudKit™. As noted above, an another benefit of the system of the present disclosure is faster processing times and usage of less computing resources in accomplishing more tasks. By tagging and the conversion language as noted above, the KPML can easily and automatically be converted to a executable language. The conversion language accordingly reduces processing time by allowing the conversion of the KPML to the executable language to be done with significantly less computing resources. The conversion language obviates the need for manual dragging and dropping assignment of styles. The conversion language of the present disclosure also improves upon automated document conversion methodologies because prior systems analyze information elements in isolation and then later commit processing power to reengineering how a single information element may be related to another information element. The design of prior systems would require many iterations and exponentially significant processing power to continually resolving the relevancy of an information element to another element in a document. The system of the present disclosure, in contrast, considers and analyzes the location of information elements and how they are organized in a document in conjunction with determining the type of information element and the flow of information elements in the document. This unique system can lead to greater efficiencies in converting a document into an executable language and can provide a system and machine learning algorithms a greater understanding of a document and its meaning. Accordingly, the executable language of the present disclosure provides the benefit of providing greater computer functions that could not before be realized. Moreover, documents are largely text based, so the conversion language reduces processing because the constant transfer of text information in prior systems was inefficient, whereas the current system uses the conversion language to convert the KPML to the executable language thereby obviating the need to handle large amounts of data.

The technology described herein provides techniques for moving from a document or other source of knowledge to an application without any technology requirement from any of the users (business or end user). This may be done in a seamless transition from the business or domain-specific environment and its natural medium (e.g., English) to the technology environment and back to the business or domain environment and its natural medium (e.g., English). Moreover, in contrast to conventional systems which require manual processing by users (e.g., at the information drafting and collection level), the technique described herein provides a fully automated system for maximum ease of use. Additionally, the technology described herein may be combined in an end product which comprises, for example, the application, collaboration platforms and tools, and project management capabilities. These various components may be integrated as a full product and/or connected to external platforms and solutions. Thus, for example, the disclosed technology can be used within classic business platforms such as Microsoft Azure™, Force.com™, and/or Apple's CloudKit™, as the modeling language allows to build processes independently of a specific proprietary system.

FIG. 8 illustrates, as one technique, a thin client computing environment 800 in which embodiments of the present invention may be implemented. In this example, a Knowledge Process Catalog 805 is generated with a plurality of knowledge processes. Each knowledge process enables the automation (e.g., via KPEL) of one or more domain-specific processes. For example, with respect to the domain of legal services, each knowledge process may be directed to the automation of a particular legal process.

Business Source Documents 830 detailing various policies and procedures are processed in Microsoft Word™ using a mark-up plug-in 835 to generate Extensible Markup Language (XML) 840 comprising information such as content, navigational specifications, data structure specifications. The XML 840 is then used to update the Knowledge Process Catalog 805. In this example, the mark-up plug-in incorporates the functionality for identifying information elements in the Business Source Documents 830. This may generally be performed by the plug-in 835 automatically although, in some embodiments, a user may manually supplement or modify the elements generated automatically with input provided to the plug-in 835. It should be noted that, although the example of FIG. 8 utilizes Microsoft Word™ and a mark-up plug-in 835, the general functionality described above may be incorporated into other form document processing tools, operating either within or outside editors such as Microsoft Word™.

An end user utilizes a Browser 810 to communicate with a Server 815 which, in turn, communicates with the Knowledge Process Catalog 805. The Server 815 receives client data and related files from the end user via the Browser 810 and stores this information in a local Data Repository 820. The client data is used in conjunction with knowledge process data from the Knowledge Process Catalog 805 to generate a response to the end user which is then present via the Browser 810. In the example of FIG. 8, the Browser 810 and Server 815 use JavaScript technologies for rendering the user interface (UI) and managing communications; however, it should be understood that other rendering and communication technologies providing similar functionality may be used in other embodiments. The thin client computing environment 800 further includes a Cache 825 which stores recently used expert systems in fast memory accessible to the Server 815, thereby allowing for faster response times to user requests. As new user requests are received and processed, this Cache 825 may be updated using any cache updating technique or algorithm generally known in the art (e.g., a least recently used algorithm).

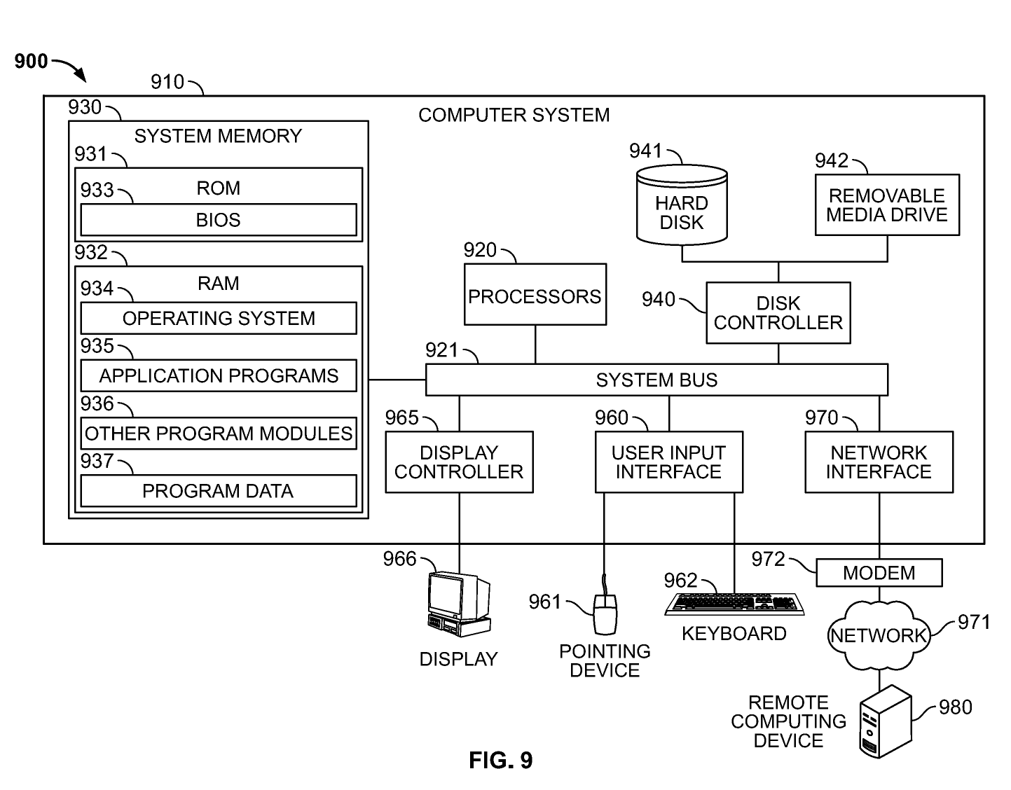

FIG. 9 illustrates an exemplary computing environment 900 within which embodiments of the invention may be implemented. For example, in some embodiments, the computing environment 900 may be used to implement one or more of the components illustrated in the system 100 of FIG. 1 or devices supporting the thin client computing environment 800 shown in FIG. 8. The computing environment 900 may include computer system 910, which is one example of a computing system upon which embodiments of the invention may be implemented. Computers and computing environments, such as computer system 910 and computing environment 900, are known to those of skill in the art and thus are described briefly here.

As shown in FIG. 9, the computer system 910 may include a communication mechanism such as a bus 921 or other communication mechanism for communicating information within the computer system 910. The computer system 910 further includes one or more processors 920 coupled with the bus 921 for processing the information. The processors 920 may include one or more central processing units (CPUs), graphical processing units (GPUs), or any other processor known in the art.

The computer system 910 also includes a system memory 930 coupled to the bus 921 for storing information and instructions to be executed by processors 920. The system memory 930 may include computer readable storage media in the form of volatile and/or nonvolatile memory, such as read only memory (ROM) 931 and/or random access memory (RAM) 932. The system memory RAM 932 may include other dynamic storage device(s) (e.g., dynamic RAM, static RAM, and synchronous DRAM). The system memory ROM 931 may include other static storage device(s) (e.g., programmable ROM, erasable PROM, and electrically erasable PROM). In addition, the system memory 930 may be used for storing temporary variables or other intermediate information during the execution of instructions by the processors 920. A basic input/output system (BIOS) 933 containing the basic routines that help to transfer information between elements within computer system 910, such as during start-up, may be stored in ROM 931. RAM 932 may contain data and/or program modules that are immediately accessible to and/or presently being operated on by the processors 920. System memory 930 may additionally include, for example, operating system 934, application programs 935, other program modules 936 and program data 937.

The computer system 910 also includes a disk controller 940 coupled to the bus 921 to control one or more storage devices for storing information and instructions, such as a hard disk 941 and a removable media drive 942 (e.g., floppy disk drive, compact disc drive, tape drive, and/or solid state drive). The storage devices may be added to the computer system 910 using an appropriate device interface (e.g., a small computer system interface (SCSI), integrated device electronics (IDE), Universal Serial Bus (USB), or FireWire).

The computer system 910 may also include a display controller 965 coupled to the bus 921 to control a display 966, such as a cathode ray tube (CRT) or liquid crystal display (LCD), for displaying information to a computer user. The computer system includes an input interface 960 and one or more input devices, such as a keyboard 962 and a pointing device 961, for interacting with a computer user and providing information to the processor 920. The pointing device 961, for example, may be a mouse, a trackball, or a pointing stick for communicating direction information and command selections to the processor 920 and for controlling cursor movement on the display 966. The display 966 may provide a touch screen interface which allows input to supplement or replace the communication of direction information and command selections by the pointing device 961.

The computer system 910 may perform a portion or all of the processing steps of embodiments of the invention in response to the processors 920 executing one or more sequences of one or more instructions contained in a memory, such as the system memory 930. Such instructions may be read into the system memory 930 from another computer readable medium, such as a hard disk 941 or a removable media drive 942. The hard disk 941 may contain one or more datastores and data files used by embodiments of the present invention. Datastore contents and data files may be encrypted to improve security. The processors 920 may also be employed in a multi-processing arrangement to execute the one or more sequences of instructions contained in system memory 930. In alternative embodiments, hard-wired circuitry may be used in place of or in combination with software instructions. Thus, embodiments are not limited to any specific combination of hardware circuitry and software.

As stated above, the computer system 910 may include at least one computer readable medium or memory for holding instructions programmed according to embodiments of the invention and for containing data structures, tables, records, or other data described herein. The term “computer readable medium” as used herein refers to any medium that participates in providing instructions to the processor 920 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 941 or removable media drive 942. Non-limiting examples of volatile media include dynamic memory, such as system memory 930. Non-limiting examples of transmission media include coaxial cables, copper wire, and fiber optics, including the wires that make up the bus 921. Transmission media may also take the form of acoustic or light waves, such as those generated during radio wave and infrared data communications.

The computing environment 900 may further include the computer system 910 operating in a networked environment using logical connections to one or more remote computers, such as remote computer 980. Remote computer 980 may be a personal computer (laptop or desktop), a mobile device, a server, a router, a network PC, a peer device or other common network node, and typically includes many or all of the elements described above relative to computer system 910. When used in a networking environment, computer system 910 may include modem 972 for establishing communications over a network 971, such as the Internet. Modem 972 may be connected to bus 921 via user network interface 970, or via another appropriate mechanism.

Network 971 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 910 and other computers (e.g., remote computer 980). The network 971 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 971.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

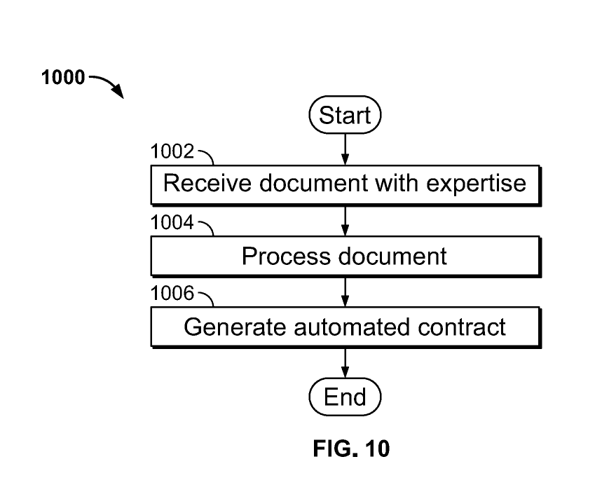

FIG. 10 is a flowchart illustrating processing steps 1000 for implementing automated form, document, and/or contract generation in the system of the present disclosure. In step 1002, the system can receive a word document having expertise or knowledge. In step 1004, the system can process the word document by leveraging the processes of the present disclosure to identify information elements and how those elements are related and what the information elements mean. In step 1006, the system can leverage the KPML of the document and the KPEL generated, and can generate an automated contract based on the KPML/KPEL. This process of the present disclosure can include machine learning to allow for better clause recognition to determine attributes including, but not limited to, parties in a transaction, jurisdiction, and terms of a non-disclosure agreement.

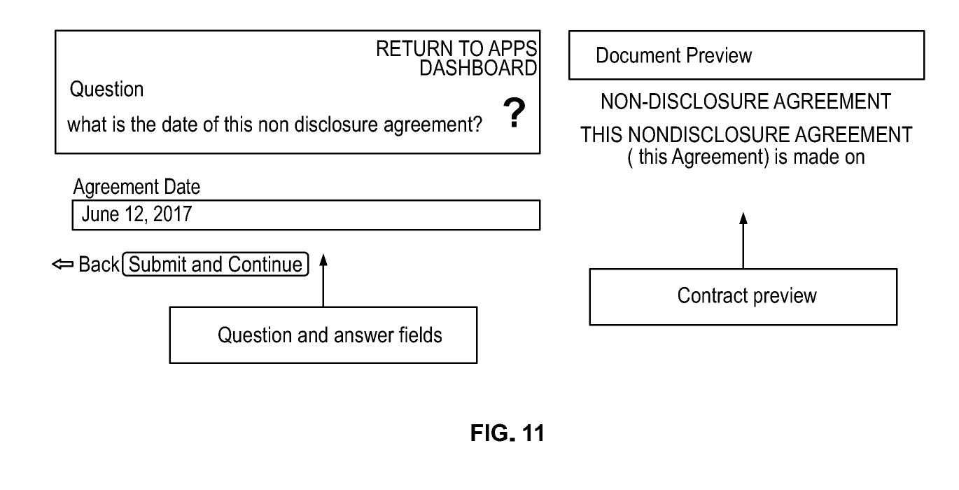

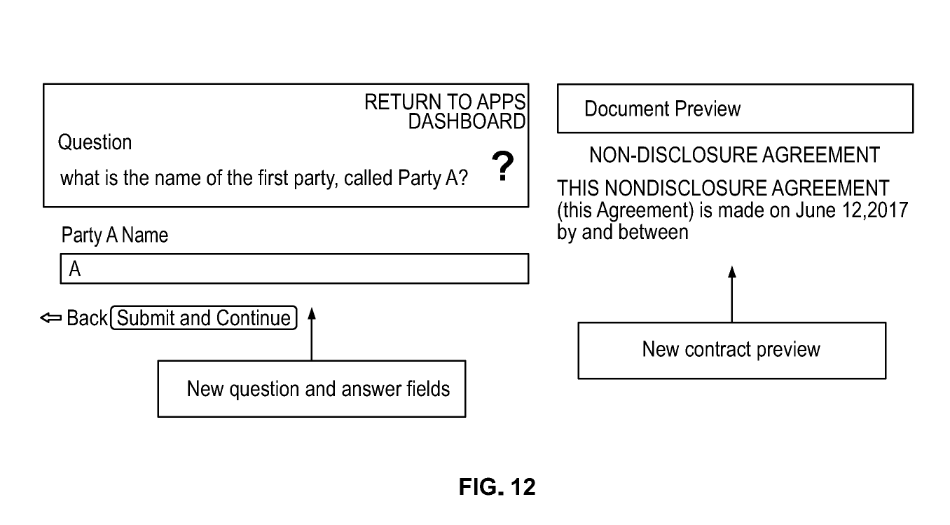

FIG. 11 is a drawing of an example graphical user interface for an application for generating an automated contract in the system of the present disclosure. On the left-hand side of the interface, a user can be presented with a question and as well a space to provide the answer. The system can receive the answer and provide a preview of the contract on the right-hand side based on the answer provided. FIG. 12 is another drawing of an example graphical user interface for generating an automated contract in the system of the present disclosure. Once the user answers the question in FIG. 11, the system can generate the clause in the contract and move on to another question as presented in FIG. 12. The system can continue the process of asking new questions and showing the preview of the contract in a cumulative fashion as the user continues through a series of questions.

The system of the present disclosure can be programmed with a number of rules for automated contract generation. No specific rule is required with the present disclosure, and the present disclosure can include any combination of rules. The system of the present disclosure can also include natural language processing rules to add clauses or choose between different clauses. Regarding the information style, the provisions of the document which do not require input are not presented in an application but can appear directly in the final generated contract. All information styles can appear in the generated contract. Regarding question style, the application can query an input from a user, and the answer can be added to the generated contract document. Regarding an answer type style, the application can propose the answer type to the user (e.g., name), and the answer can be added to the final contract document. If there are options for an answer (e.g., Q: Are you happy), the options can be presented in the application as decision branches (a.1—if you are) (a.2—if you are not). The system can also provide the option to add a clause by drafting a custom clause, which the application can ask for. The clause can then be added to the final document. For situations where the answer cannot be predetermined, the answer can be identified through location in the document (e.g., location Title X-Subtitle Y-Section Z—(d.1)), as was discussed in greater detail above. Such an answer may not appear in the application but can appear in the appropriate location in the final contract document. The system can provide a choice between two provisions, in which case the system can ask the question with the keywords “select to include.” The clause chosen can be added to the document and the choices can appear in the application.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

What is claimed is:

1. A method for automating knowledge-based processes and operations, the method comprising:
receiving, by a computer, an information dataset comprising knowledge;
organizing, by the computer, the information dataset into a plurality of information elements;
tagging, by the computer, the plurality of information elements with information that reflects at least one characteristic for each of the plurality of information elements;
organizing, by a conversion language of the computer, the plurality of information elements to reflect relationships between the plurality of information elements and a flow between all of the information elements;
mapping, by the computer, the plurality of information elements into knowledge processes expressed in a knowledge process modeling language;
performing, by the computer, at least one of (i) converting the knowledge processes into a knowledge process executable language and (ii) translating the knowledge processes into a business process model language and converting the translated knowledge processes into a business process executable language.

2. The method of claim 1, wherein the information dataset comprises a document or text and the information elements comprise document or text elements.

3. The method of claim 1, comprising:
receiving, by the computer, a voice dictation comprising the knowledge; and
automatically transcribing, by the computer, the voice dictation into the information dataset.

4. The method of claim 1, wherein receiving the information dataset comprises:
extracting at least a portion of the knowledge from one or more e-mail or social media data feeds.

5. The method of claim 1, wherein the information dataset is organized into information elements by:
determining a domain corresponding to the information dataset;
identifying the plurality of information elements in the information dataset based on a plurality of domain-specific semantic knowledge structures.

6. The method of claim 5, wherein each domain-specific semantic knowledge structure corresponds to at least one of a word, symbol, or phrase associated with the domain or a natural language associated with the domain.

7. The method of claim 5, wherein each domain-specific semantic knowledge structure corresponds to at least one of a font and a style of formatting associated with the domain.

8. The method of claim 5, wherein each domain-specific semantic knowledge structure corresponds to at least one of a numbering and a notation style associated with the domain.

9. The method of claim 1, wherein a trained machine learning model is used to automatically perform the mapping of the plurality of information elements into the knowledge processes using the knowledge process modeling language.

10. The method of claim 1, wherein a trained machine learning model is used to automatically perform the translation of the knowledge processes into the business process model language.

11. The method of claim 1, comprising:
using at least one of the business process executable language and the knowledge process executable language to automate one or more knowledge-based processes.

12. The method of claim 1, further comprising the step of generating, automatically, a contract based on the knowledge processes and the knowledge process executable language.

13. The method of claim 12, further comprising the step of prompting a user with a plurality of questions and inserting a plurality of new clauses into the contract based on answers provided in response to the plurality of questions.

14. An article of manufacture for automating knowledge-based processes and operations, the article of manufacture comprising a non-transitory, tangible computer-readable medium holding computer-executable instructions for performing a method comprising:
receiving an information dataset comprising knowledge;
organizing an information dataset comprising knowledge into a plurality of information elements;
tagging, the plurality of information elements with information that reflects at least one characteristic for each of the plurality of information elements;
organizing, by a conversion language of the computer, the plurality of information elements to reflect relationships between the plurality of information elements and a flow between all of the information elements;
mapping the plurality of information elements into knowledge processes expressed in a knowledge process modeling language;
performing one or more of (i) converting the knowledge processes into a knowledge process executable language or (ii) translating the knowledge processes into a business process model language and converting the translated knowledge processes into a business process executable language.

15. The article of manufacture of claim 14, wherein the information dataset comprises a document or text and the information elements comprise document or text elements.

16. The article of manufacture of claim 14, wherein the method further comprises:
receiving a voice dictation comprising the knowledge; and
automatically transcribing the voice dictation into the information dataset.

17. The article of manufacture of claim 14, wherein receiving the information dataset comprises:
extracting at least a portion of the knowledge from one or more e-mail or social media data feeds.

18. The article of manufacture of claim 14, wherein the information dataset is organized into information elements by:
determining a domain corresponding to the information dataset;
identifying the plurality of information elements in the information dataset based on a plurality of domain-specific semantic knowledge structures.

19. The article of manufacture of claim 18, wherein each domain-specific semantic knowledge structure corresponds to at least one of a word, symbol, or phrase associated with the domain or a natural language associated with the domain.

20. The article of manufacture of claim 18, wherein each domain-specific semantic knowledge structure corresponds to at least one of a font or style of formatting associated with the domain.

21. The article of manufacture of claim 18, wherein each domain-specific semantic knowledge structure corresponds to at least one of a numbering or notation style associated with the domain.

22. The article of manufacture of claim 14, wherein a trained machine learning model is used to automatically perform the mapping of the plurality of information elements into the knowledge processes using the knowledge process modeling language.

23. The article of manufacture of claim 14, wherein a trained machine learning model is used to automatically perform the translation of the knowledge processes in the business process model language.

24. The article of manufacture of claim 14, wherein the method further comprises:
using the business process executable language or the knowledge process executable language to automate one or more knowledge-based processes.

25. The article of manufacture of claim 14, wherein the method further comprises the step of generating, automatically, a contract based on the knowledge processes and the knowledge process executable language.

26. The article of manufacture of claim 25 , wherein the method further comprises the step of prompting a user with a plurality of questions and inserting a plurality of new clauses into the contract based on answers provided in response to the plurality of questions.

27. A system for automating knowledge-based processes and operations, the system comprising:
a knowledge user interface configured to receive an information dataset comprising expertise-related knowledge;
a knowledge processing computer configured to:
receive an information dataset comprising knowledge;
organize the information dataset comprising knowledge into a plurality of information elements;
tag the plurality of information elements with information that reflects at least one characteristic for each of the plurality of information elements;
organize, by a conversion language, the plurality of information elements to reflect relationships between the plurality of information elements and a flow between all of the information elements;
map the plurality of information elements into knowledge processes expressed in a knowledge process modeling language;
perform one or more of (i) converting the knowledge processes into a knowledge process executable language or (ii) translating the knowledge processes into a business process model language and converting the translated knowledge processes into a business process executable language.

28. The system of claim 23, wherein the knowledge processing computer is further configured to use the business process executable language or the knowledge process executable language to automate one or more knowledge-based processes.
